(19) United States
(12) Patent Application Publication
(10) Pub. No.: US 2007/0068793 A1
(43) Pub. Date: Mar. 29, 2007

(54) Electrode for discharge surface treatment, manufacturing method for electrode for discharge surface treatment, discharge surface treatment apparatus, and discharge surface treatment method

(75) Inventors: Akihiro Goto, Tokyo (JP); Masao Akiyoshi, Tokyo (JP); Katsuhiro Matsuo, Aichi (JP); Hiroyuki Ochiai, Tokyo (JP); Mitsutoshi Watanabe, Tokyo (JP); Takashi Furukawa, Tokyo (JP)

Correspondence Address: SUGHRUE MION, PLLC, 2100 PENNSYLVANIA AVENUE, N.W., SUITE 800, WASHINGTON, DC, 20037, US

(73) Assignees: Mitsubishi Denki Kabushiki Kaisha; Ishikawajima-Harima Heavy Industries Co., Ltd.

(21) Appl. No.: 10/558,384

(22) PCT Filed: Jan. 28, 2004
(86) PCT No.: PCT/JP04/00742

§ 371 Date: Sep. 5, 2006

(30) Foreign Application Priority Data
May 29, 2003 (JP) 2003-152578
Jun. 5, 2003 (JP) 2003-160506
Jun. 11, 2003 (JP) 2003-166013
Jun. 11, 2003 (JP) 2003-166015

(51) Int. Cl. H05F 3/00; C25B 11/00; B28B 3/02; B02B 5/02

(52) U.S. Cl. 204/164; 204/284; 264/319; 241/25

(57) ABSTRACT

An electrode is used for discharge surface treatment of a work piece. The electrode is made of a green compact obtained by compression-molding an electrode material including powder of any of a metal and a metallic compound, and the discharge surface treatment generating an electric discharge between the electrode and the work piece in an atmosphere of a machining medium and forming a film of a machining material on a surface of a work piece using energy produced by the electric discharge. The powder has an average particle diameter of not less than 10 nanometers and not more than 3 micrometers, and the electrode material of the electrode has substantially uniform composition and capable of forming a thick film with thickness not less than 100 micrometers.

### TECHNICAL FIELD

The present invention relates to an electrode for discharge surface treatment that is used for discharge surface treatment for causing pulsed electric discharge between an electrode for discharge surface treatment, which consists of a green compact obtained by compression-molding powder of metal, a metallic compound, or ceramics, and a work piece and forming, using discharge energy of the electric discharge, a film consisting of an electrode material or a substance generated by reaction of the electrode material due to the discharge energy on a surface of the work piece and a manufacturing method for the electrode for discharge surface treatment. The present invention also relates to a discharge surface treatment apparatus and a discharge surface treatment method using the electrode for discharge surface treatment.

### BACKGROUND ART

In recent years, there is an increasing demand for a film having abrasion resistance and lubricity under a high-temperature environment such as use in a turbine blade or the like of a gas turbine engine for an air craft. FIG. 1 is a schematic of a structure of a turbine blade of a gas turbine engine for an aircraft. As shown in the figure, a plurality of turbine blades 1000 are fixed in contact with one another and rotate around a not shown shaft. Contact portions P of these turbine blades 1000 are severely abraded and struck under a high-temperature environment when the turbine blades 1000 rotate.

Under such a high-temperature environment (700° C. or more) in which the turbine blades 1000 are used, an abrasion resistant film or a film having a lubricating action, which are used in the room temperature, have little effect because the film is oxidized under the high-temperature environment. Therefore, a film (a thick film) of an alloy material containing metal (Cr (chrome), Mo (molybdenum), etc.) generating oxide having lubricity at high temperature is formed on the turbine blades 1000 and the like. Such a film is formed by a method like welding or thermal spraying. Thermal spraying refers to a machining method of jetting powder with a particle diameter of about 50 micrometers from a nozzle, melting a part of the powder at a nozzle exit, and forming a film on a surface of a work piece (hereinafter, “work”). Welding refers to a machining method of causing an arc between an electrode and a work, melting a part of the electrode with heat of the arc to from droplets, and transferring the droplets to the surface of the work to form a film.

The methods such as the welding and thermal spraying are manual machining and require skill. Thus, there is a problem in that it is difficult to automate the machining and cost for the machining increases. In particular, since the welding is a method of concentrating heat in a work, there is a problem in that weld crack tends to occur and yield is low when a thin material is treated and when a fragile material, for example, a single crystal alloy or a directional control alloy like a directionally solidified alloy is treated.

On the other hand, a method of forming a film on a surface of a work with pulse-like electric discharge (hereinafter, “discharge surface treatment”) is disclosed in a Patent Document 1 and the like. This discharge surface treatment is treatment for causing arc discharge between an electrode, which consists of a green compact obtained by compress-molding powder to be as hard as a chalk, and a work and re-solidifying a material forming the electrode melted by the arc discharge on a surface of the work to form a film. The discharge surface treatment attracts attention as a technology capable of automating machining.

For example, in the conventional discharge surface treatment, a film of a hard material like TiC (titanium carbide) having abrasion resistance at the room temperature is formed. Besides, to improve abrasion resistance of a component and a die, in the discharge surface treatment, for example, an electrode obtained by compress-molding powder of WC (tungsten carbide) with an average particle diameter of about 1 micrometer is used to form a film of a hard material less easily oxidized like cemented carbide or ceramics.

Patent Document 1

International Publication No. 99/58744 pamphlet

In the conventional discharge surface treatment, the main purpose is to form a thin film of a hard material such as TiC or WC having abrasion resistance at the room temperature. Therefore, formation of the film having abrasion resistance and lubricity under a high-temperature environment used for a turbine blade or the like of a gas turbine engine for an aircraft is not performed.

There is also an increasing demand for formation of a thick film with thickness not less than about 100 micrometers using the discharge surface treatment that can automate machining in addition to formation of a hard ceramic film aiming at abrasion resistance at the room temperature. However, in the electrode manufacturing method described in the Patent Document 1, since formation of a thick film by the discharge surface treatment is the main object, it is impossible to directly apply the electrode manufacturing method to thin film formation.

In the formation of a thick film by the discharge surface treatment, it is possible that methods of supplying a material from an electrode side and melting the material supplied on a surface of a work affect film performance most. What affects the supply of an electrode material is strength, that is, hardness of the electrode. Specifically, it is considered desirable that the electrode has uniform hardness. However, in the Patent Document 1, since formation of an electrode with uniform hardness at the time of compression molding of powder is not taken into account, it is likely that fluctuation occurs in hardness of the electrode itself. In forming a thin film as described in the Patent Document 1, since a film to be formed is thin, the film is hardly affected even if hardness of the electrode is not uniform a little. On the other hand, in forming a thick film, it is possible to form a film with uniform thickness only when a large quantity of an electrode material is uniformly supplied to a treatment area. However, if hardness of the electrode is not uniform even a little, since a difference occurs in formation of a film among portions where the hardness is not uniform, it is impossible to form a film with uniform thickness. There is also a problem in that, when an electrode with nonuniform electrode hardness is used, since fluctuation occurs in formation speed and a characteristic of a film depending on a place of an electrode used in performing the discharge surface treatment, it is impossible to obtain a dense film and perform surface treatment of a constant quality.

Powder of metal or ceramics is generally manufactured by an atomizing method. However, there is a problem in that powder with a particle diameter not more than 3 micrometers is extremely expensive because only about several percent of entire treated powder can be collected and, since a quality of collection is affected by a change in an ambient environment, yield is low. In general, since it is said that a limit of a particle diameter of powder that can be manufactured by the atomizing method is about 6 micrometers, it is extremely difficult to obtain powder with a particle diameter not more than 3 micrometers. Moreover, since powder manufactured by the atomizing method is manufactured by evaporating a material and condensing the material, obtained powder has a spherical shape because of an influence of a surface tension. There is also a problem in that, when an electrode is formed of such spherical powder, since powder particles are in point contact with one another, bonding among the particles is weakened to make the powder fragile.

The present invention has been devised in view of the problems and it is an object of the present invention to obtain an electrode for discharge surface treatment that has uniform hardness, has uniform thickness at the time of the discharge surface treatment, and is capable of forming a thick film with thickness not less than about 100 micrometers.

It is another object of the present invention to obtain an electrode for discharge surface treatment that has uniform hardness and is capable of forming a uniform and sufficiently dense thick film at the time of the discharge surface treatment. It is still another object of the present invention to obtain an electrode for discharge surface treatment that is capable of forming a thick film having abrasion resistance and lubricity under a high-temperature environment.

It is still another object of the present invention to obtain a discharge surface treatment apparatus that uses the electrode for discharge surface treatment and a method for the discharge surface treatment apparatus.

### DISCLOSURE OF INVENTION

To achieve the objects, according to an aspect of the present invention, in an electrode for discharge surface treatment that is used for discharge surface treatment for causing, with a green compact obtained by compression-molding powder containing metal or a metallic compound as an electrode, electric discharge between the electrode and a work piece in a machining fluid or in an air and forming, using discharge energy of the electric discharge, a film consisting of an electrode material or a substance generated by reaction of the electrode material due to the discharge energy on a surface of the work piece, the powder has an average value of particle diameters not more than 3 micrometers.

According to another aspect of the present invention, in an electrode for discharge surface treatment that is used for discharge surface treatment for causing, with a green compact obtained by compression-molding powder of metal, a metallic compound, or ceramics as an electrode, electric discharge between the electrode and a work piece in a machining fluid or in an air and forming, using discharge energy of the electric discharge, a film consisting of an electrode material or a substance generated by reaction of the electrode material due to the discharge energy on a surface of the work piece, the powder has an aspherical shape.

According to still another aspect of the present invention, in an electrode for discharge surface treatment that is used for discharge surface treatment for causing, with a green compact obtained by compression-molding powder of metal or a metallic compound as an electrode, electric discharge between the electrode and a work piece in a machining fluid or in an air and forming, using discharge energy of the electric discharge, a film consisting of an electrode material or a substance generated by reaction of the electrode material due to the discharge energy on a surface of the work piece, the powder is obtained by mixing a small-diameter powder having a distribution of small particle diameters and a large-diameter powder having an average particle diameter twice or more as large as the small-diameter powder.

According to still another aspect of the present invention, in an electrode for discharge surface treatment that is used for discharge surface treatment for causing, with a green compact obtained by compression-molding powder of metal, a metallic compound, or ceramics as an electrode, electric discharge between the electrode and a work piece in a machining fluid or in an air and forming, using discharge energy of the electric discharge, a film consisting of an electrode material or a substance generated by reaction of the electrode material due to the discharge energy on a surface of the work piece, the powder has an average value of particle diameters not more than 1 micrometer.

Moreover, to achieve the objects, according to still another aspect of the present invention, a manufacturing method for an electrode for discharge surface treatment, includes a first step of grinding powder of metal, a metallic compound, or ceramics into aspheric powder having a predetermined particle diameter with a grinder; and a second step of compress-molding the powder ground into a predetermined shape to have predetermined hardness.

Moreover, to achieve the objects, according to still another aspect of the present invention, in a discharge surface treatment method of causing, with a green compact obtained by compression-molding powder containing metal or a metallic compound as an electrode, electric discharge between the electrode and a work piece in a machining fluid or in an air and forming, using discharge energy of the electric discharge, a film consisting of an electrode material or a substance generated by reaction of the electrode material due to the discharge energy on a surface of the work piece, the film is formed using an electrode obtained by compression-molding powder with an average value of particle diameters not more than 3 micrometers.

According to still another aspect of the present invention, in a discharge surface treatment method of causing, with a green compact obtained by compression-molding powder of metal or a metallic compound as an electrode, electric discharge between the electrode and a work piece and forming, using discharge energy of the electric discharge, a film consisting of an electrode material or a substance generated by reaction of the electrode material due to the discharge energy on a surface of the work piece, the film is formed using an electrode obtained by mixing a small-diameter powder having a distribution of small particle diameters and a large-diameter powder having an average particle diameter twice or more as large as the small-diameter powder and compression-molding the powders.

According to still another aspect of the present invention, in a discharge surface treatment method of causing electric discharge between an electrode consisting of a green compact obtained by compression-molding powder with an average value of particle diameters not more than 1 micrometer and a work piece and forming, using discharge energy of the electric discharge, a film consisting of an electrode material or a substance generated by reaction of the electrode material due to the discharge energy on a surface of the work piece.

Moreover, to achieve the objects, according to still another aspect of the present invention, in a discharge surface treatment apparatus that has an electrode consisting of a green compact obtained by compression-molding powder containing metal or a metallic compound and a work piece on which a film is formed, the electrode and the work piece being arranged in a machining fluid or in an air, generates a pulse-like electric discharge between the electrode and the work piece using a power supply apparatus electrically connected to the electrode and the work piece, and forms, using discharge energy of the electric discharge, a film consisting of an electrode material or a substance generated by reaction of the electrode material due to the discharge energy on a surface of the work piece, the electrode is manufactured by compression-molding powder having an average value of particle diameters not more than 3 micrometers.

According to still another aspect of the present invention, a discharge surface treatment apparatus includes an electrode consisting of a green compact obtained by compression-molding powder of metal or a metal compound; a work piece on which a film is formed; and a power supply apparatus electrically connected to the electrode and the work piece, the discharge surface treatment apparatus generating pulse-like electric discharge between the electrode and the work piece with the power supply apparatus and forming, using discharge energy of the discharge, a film consisting of an electrode material or a substance generated by reaction of the electrode material due to the discharge energy on a surface of the work piece. The electrode is manufactured by compression-molding powder obtained by mixing a small-diameter powder having a distribution of small particles and a large-diameter powder having an average particle diameter twice or more as large as the small-diameter powder.

According to still another aspect of the present invention, in a discharge surface treatment apparatus includes an electrode consisting of a green compact obtained by compression-molding powder with an average value of particle diameters not more than 1 micrometer; a work piece on which a film is formed; and a power supply apparatus electrically connected to the electrode and the work piece, the discharge surface treatment apparatus generating pulse-like electric discharge between the electrode and the work piece with the power supply apparatus and forming, using discharge energy of the discharge, a film consisting of an electrode material or a substance generated by reaction of the electrode material due to the discharge energy on a surface of the work piece.

### BRIEF DESCRIPTION OF DRAWINGS

FIG. 1 is a schematic of a structure of a turbine blade of a gas turbine engine for an aircraft;

FIG. 2 is a schematic of discharge surface treatment in a discharge surface treatment apparatus;

FIG. 3A is a chart of a voltage waveform of a voltage applied between an electrode for discharge surface treatment at the time of electric discharge and a work;

FIG. 3B is a chart of a current waveform of a current flowing to the discharge surface treatment apparatus at the time of electric discharge;

FIG. 4 is a flowchart of an example of a manufacturing process for an electrode for discharge surface treatment;

FIG. 5 is a schematic sectional view of a state of a molding device at the time when powder is molded;

FIG. 6 is a schematic of a hardness fluctuation test;

FIG. 7 is a graph of a granularity distribution of stellite powder after grinding 50 hours;

FIG. 8 is an SEM (Scanning Electron Microscope) photograph of a state of the inside of an electrode manufactured from scaly stellite powder with an average particle diameter of 1.8 micrometers;

FIG. 9 is an SEM photograph of a state of the inside of an electrode manufactured as a comparative example from spherical stellite powder with an average particle diameter of 6 micrometers;

FIG. 10 is a photograph of a deposition state of powder processed under this condition;

FIG. 11 is a schematic of a grinding principle of a bead mill apparatus;

FIG. 12 is a graph of a granularity distribution of stellite powder after grinding six hours;

FIG. 13 is a schematic of a constitution of an electrode material in an eighth embodiment of the present invention;

FIG. 14A is an SEM photograph of a state of a film at the time when the discharge surface treatment is performed with small discharge energy using an electrode containing large-diameter powder at a ratio of 10%;

FIG. 14B is an SEM photograph of a state of a film at the time when the discharge surface treatment is performed with small discharge energy using an electrode containing large-diameter powder at a ratio of 50%;

FIG. 14C is an SEM photograph of a state of a film at the time when the discharge surface treatment is performed with large discharge energy using an electrode containing large-diameter powder at a ratio of 50%;

FIG. 14D is an SEM photograph of a state of a film at the time when the discharge surface treatment is performed with small discharge energy using an electrode containing large-diameter powder at a ratio of 80%;

FIG. 14E is an SEM photograph of a state of a film at the time when the discharge surface treatment is performed with large discharge energy using an electrode containing large-diameter powder at a ratio of 80%;

FIG. 15 is a graph of a relation between a ratio of large-diameter powder and density of a film;

FIG. 16 is a graph of a relation between a ratio of large-diameter powder and moldability of an electrode;

FIG. 17 is an SEM photograph of a state of a section of a film formed by the discharge surface treatment using an electrode manufactured from powder obtained by mixing Co-based metal powder with a particle diameter of 6 micrometers and Co-based metal powder with a particle diameter of 1 micrometer at a ratio of 4:1;

FIG. 18 is a graph of a relation between a particle diameter of powder forming an electrode and porosity of a film; and

FIG. 19 is an SEM photograph of a state of a section of a film formed by the discharge surface treatment using an electrode manufactured from Co alloy powder with a particle diameter of 0.7 micrometer.

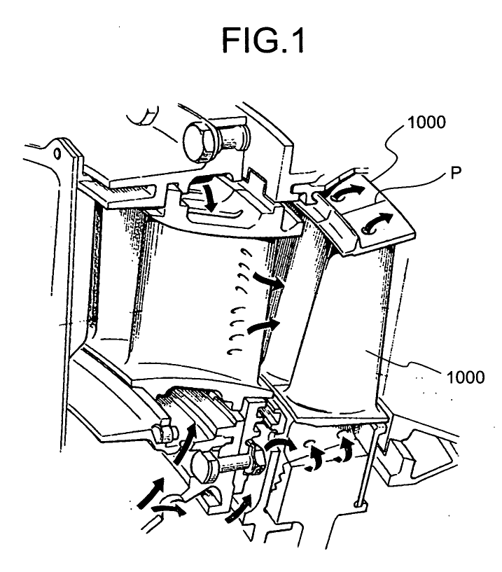

### BEST MODE(S) FOR CARRYING OUT THE INVENTION

Exemplary embodiments of an electrode for discharge surface treatment, a manufacturing method for the electrode for discharge surface treatment, a discharge surface treatment apparatus, and a discharge surface treatment method according to the present invention are explained in detail below.

### First Embodiment

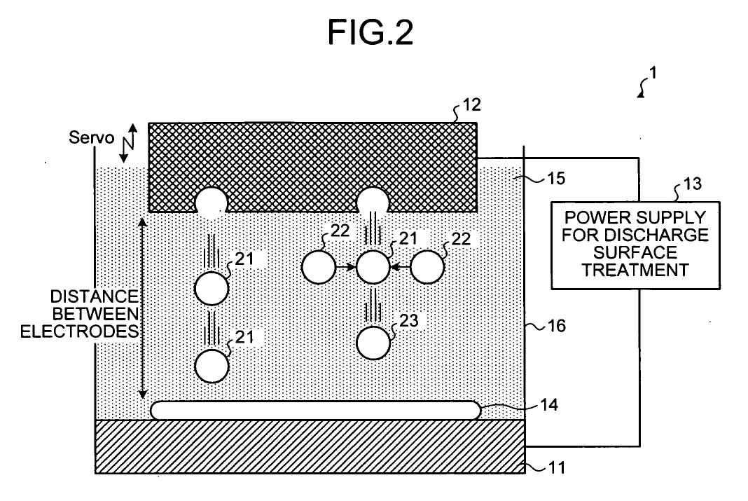

First, a discharge surface treatment method and an apparatus therefor used in the present invention are schematically explained. FIG. 2 is a diagram schematically showing discharge surface treatment in a discharge surface treatment apparatus. A discharge surface treatment apparatus 1 includes a work piece (hereinafter, “work”) 11 on which a film 14 is formed, an electrode for discharge surface treatment 12 for forming the film 14 on the surface of the work 11, and a power supply for discharge surface treatment that supplies a voltage to both the work 11 and the electrode for discharge surface treatment 12 to cause arc discharge between both the work 11 and the electrode for discharge surface treatment 12 electrically connected. When the discharge surface treatment is performed in a liquid, a work tank is further provided and the work 11 and a portion of the electrode for discharge surface treatment 12 opposed to the work 11 are filled with a machining fluid 15 such as oil. When the discharge surface treatment is performed in the air, the work 11 and the electrode for discharge surface treatment 12 are placed in a treatment atmosphere. Note that, in an example shown in FIG. 2 and explained below, the discharge surface treatment is performed in a machining fluid. In the following explanation, the electrode for discharge surface treatment is simply called an “electrode”. Moreover, in the following explanation, a distance between opposed surfaces of the electrode for discharge surface treatment 12 and the work 11 is referred to as a distance between electrodes.

A discharge surface treatment method in the discharge surface treatment apparatus 1 having such a constitution is explained below. The discharge surface treatment is performed by, for example, with the work 11 on which the film 14 is desired to be formed set as an anode and the electrode for discharge surface treatment 12, which is obtained by molding powder with an average particle diameter of 10 nanometers to several micrometers such as metal and ceramics, serving as a supply source of the film 14 set as a cathode, causing electric discharge between the anode and the cathode while controlling the distance between electrodes with a not shown control mechanism to prevent both the electrodes from coming into contact with each other in the machining fluid 15.

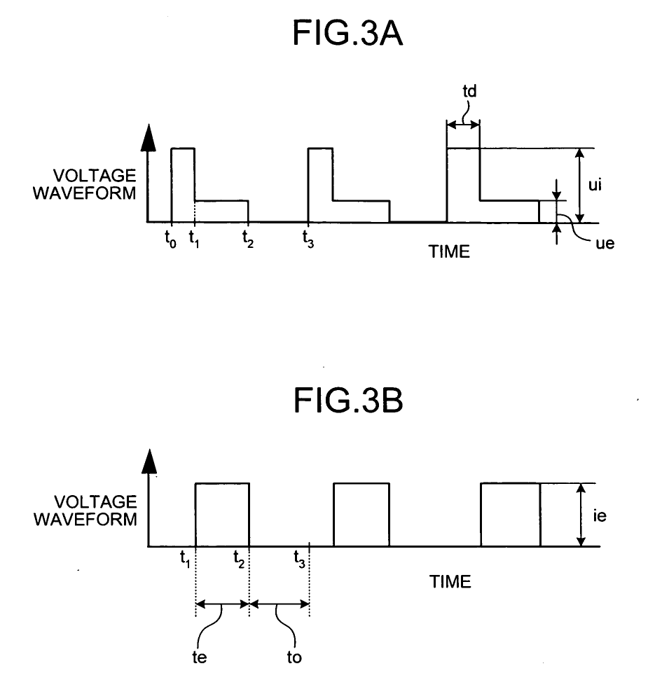

FIGS. 3A and 3B are charts of examples of a pulse condition of electric discharge at the time of the discharge surface treatment. FIG. 3A is a chart of a voltage waveform of a voltage applied between an electrode for discharge surface treatment at the time of electric discharge and a work. FIG. 3B is a chart of a current waveform of a current flowing to a discharge surface treatment apparatus at the time of discharge. As a polarity of the voltage in FIG. 3A, a negative polarity on the electrode 12 side viewed from the work 11 side is set as a positive side on the voltage waveform chart. As a polarity of the current in FIG. 3B, a direction in which the current flows from the electrode 12 to the work 11 through the power supply for discharge surface treatment 13 is set as a positive side. As shown in FIG. 3A, a no-load voltage ui is applied between both the electrodes at time t₀. A current starts flowing between both the electrodes at time t₁ after elapse of discharge delay time td and electric discharge starts. The voltage at this point is a discharge voltage ue and the current flowing at this point has a peak current value ie. When supply of the voltage between both the electrodes is stopped at time t₂, the current stops flowing. In other words, the electric discharge stops. In this case, t₂-t₁ is referred to as a pulse width te. A voltage with a voltage waveform at time t₀ to t₂ is repeatedly applied between both the electrodes at intervals of a quiescent time to.

When electric discharge occurs between the electrode for discharge surface treatment and the work 11, part of the work and the electrode 12 melt by the heat generated due to the electric discharge. When a binding force among particles of the electrode 12 is weak, a part (hereinafter, electrode particles) 21 of the electrode 12 melted is separated from the electrode 12 by air blast and a static electric force caused by the electric discharge and moves to the surface of the work 11. When the electrode particles 21 reach the surface of the work 11, the electrode particles 21 solidify again and change to the film 14. A part of the electrode particles 21 reacting with components 22 in the machining fluid 15 or the air also forms the film 14 on the surface of the work 11. In this way, the film 14 is formed on the surface of the work 11. However, when a binding force among particles of the electrode 12 is strong, the electrode 12 is not stripped off by air blast and a static electrical force due to the electric discharge. Thus, it is impossible to supply an electrode material to the work 11. In other words, possibility of formation of a thick film according to the discharge surface treatment is affected by supply of a material from the electrode 12 side, melting of the material supplied on the surface of the work 11 and a way of bonding of the material with the material of the work 11. Hardness of the electrode 12 affects the supply of an electrode material.

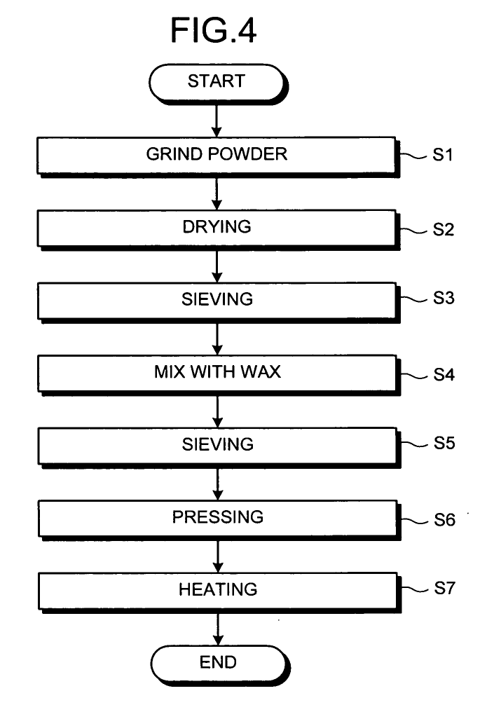

An example of a method of manufacturing the electrode for discharge surface treatment 12 used for the discharge surface treatment is explained. FIG. 4 is a flowchart of a process for manufacturing an electrode to be used in discharge surface treatment. Note that, in the flowchart shown in FIG. 4, some steps may be unnecessary in manufacturing an electrode for discharge surface treatment. For example, when it is possible to obtain powder with a small diameter with an average particle diameter not more than 3 micrometers, a grinding step explained below is unnecessary.

First, powder of metal, ceramics, or the like having a component of the film 14 desired to be formed on the work 11 is ground (step S1). When the film 14 consists of a plurality of components, powders of the respective components are mixed and ground such that a desired ratio of the components is obtained. For example, spherical powder of metal, ceramics, with an average particle diameter of several tens micrometers circulated in the market is ground into powder with an average particle diameter not more than 3 micrometers by a grinder like a ball mill apparatus. The grinding may be performed in a liquid. However, in this case, the liquid is evaporated to dry the powder (step S2). In the powder after drying, particles are aggregated with each other to form a large mass, and the large mass is taken apart into pieces and sieved to sufficiently mix a wax used at the next step and the powder (step S3). For example, when a ceramic sphere or a metal sphere is placed on a net of a sieve, on which the aggregated powder remain, and the net is vibrated, the mass formed by aggregation is taken apart by energy of the vibration and collision with the sphere and passes through meshes of the net. Only the powder passing through the meshes of the net is used at a step described below.

The process of sieving performed at step S3 is explained in detail below. In the discharge surface treatment, a voltage applied between the electrode for discharge surface treatment 12 and the work 11 to cause electric discharge is usually in a range of 80 volts to 400 volts. When a voltage in this range is applied between the electrode 12 and the work 11, a distance between the electrode 12 and the work 11 during the discharge surface treatment is set to about 0.3 millimeter. As described above, in the discharge surface treatment, the aggregated mass forming the electrode 12 may leave the electrode 12 because of arc discharge caused between both the electrodes while keeping a size of the mass. If the size of the mass is not more than the distance between electrodes (not more than 0.3 millimeter), it is possible to cause the next electric discharge even if the mass is present between the electrodes. Since electric discharge occurs in places in a short distance from each other, electric discharge occurs in a place where the mass is present and it is possible to crash the mass into small pieces with thermal energy and an explosive force of the electric discharge.

However, when the size of the mass forming the electrode 12 is not less than the distance between electrodes (not more than 0.3 millimeter), the mass leaves from the electrode 12 because of electric discharge while keeping the size and is deposited on the work 11 or drifts in an interelectrode space filled with the machining fluid 15 between the electrode 12 and the work 11. When the large mass is deposited, since electric discharge occurs in a place where a distance between the electrode 12 and the work 11 is less, electric discharge concentrates in that place (i.e., where the large mass is present) and cannot be caused in other places. Thus, it is impossible to uniformly deposit the film 14 on the surface of the work 11. Moreover, it is difficult to completely melt large masses with heat of the electric discharge. Thus, the film 14 is so fragile as to be shaved by a hand. When the large mass drifts in the interelectrode space, the electrode 12 and the work 11 are short-circuited so that an electric discharge does not occur. In other words, to uniformly form the film 14 and obtain stable electric discharge, a mass not less than a distance between electrodes, which is formed by aggregation of powder, must not be present in the powder forming the electrode. The aggregation of the powder is likely to occur in the case of metal powder and conductive ceramics and is less likely to occur in the case of nonconductive powder. The aggregation of the powder is more likely to occur as an average particle diameter of the powder is reduced. Therefore, to prevent a harmful effect during the discharge surface treatment due to a mass generated by such aggregation of the powder, a step of sieving the aggregated powder at step S3 is required. To that effect, in sieving the powder, it is necessary to use meshes of a net smaller than the distance between electrodes.

Thereafter, to make transmission of a pressure of press to the inside of the powder better in the case of press at a later step, wax like paraffin is mixed at a weight ratio of 1% to 10% (step S4). When the powder and the wax are mixed, although it is possible to improve moldability, since the periphery of the powder is covered with a liquid again, the powder is aggregated by an intermolecular force of the powder and a static electrical force to form a large mass. Thus, the mass aggregated is sieved again to be taken apart into pieces (step S5). A way of sieving is the same as the method at step S3 described above.

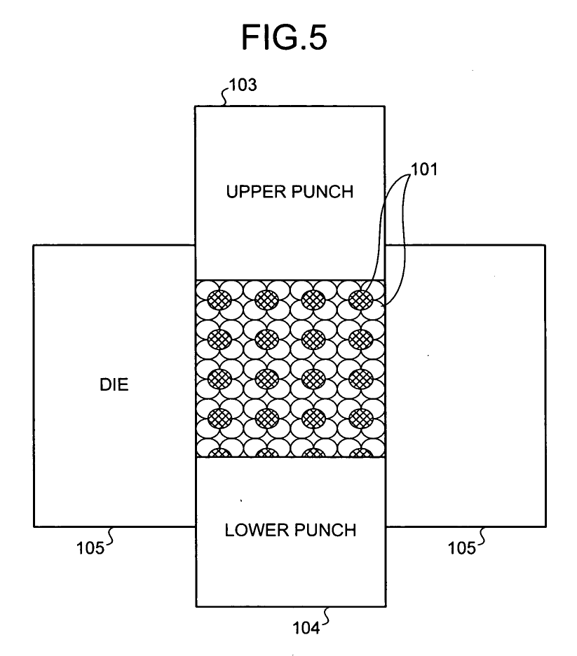

Subsequently, powder obtained at step S5 is molded by a compression press (step S6). FIG. 5 is a schematic sectional view of a state of a molding device at the time when powder is molded. A lower punch 104 is inserted from a bottom of a hole formed in a die 105. Powder (a mixture of the powders when the powders consist of a plurality of components) sieved at step S5 is filled in a space formed by the lower punch 104 and the die 105. Thereafter, an upper punch 103 is inserted from a top of the hole formed in the die 105. Pressure is applied from both sides of the upper punch 103 and the lower punch 104 of the molding device filled with such powder 101 by a pressurizer or the like to compression-mold the powder 101. In the following explanation, the powder 101 compression-molded is referred to a green compact. In this case, the electrode 12 is hardened when a press pressure is increased. The electrode 12 is softened when the press pressure is decreased. The electrode 12 is hardened when a particle diameter of the powder 101 of the electrode material is small. The electrode 12 is softened when a particle diameter of the powder 101 is large.

Thereafter, the green compact is taken out from the molding device and heated in a vacuum furnace or a furnace of a nitrogen atmosphere to the extent that the hardness becomes substantially equal to the hardness of chalk (step S7). In the case of heating, the electrode 12 is hardened when a heating temperature is raised and the electrode 12 is softened when a heating temperature is lowered. It is also possible to lower an electric resistance of the electrode 12 by heating the green compact. Therefore, at step 7, it is meaningful to heat the green compact even when the powder is compression-molded without mixing wax in the powder at step S4. Consequently, bonding among the powders in the green compact progresses and the electrode for discharge surface treatment 12 having electrical conductivity is manufactured.

As functions required of thick film formation in the discharge surface treatment in the first and the second embodiments described below, there are abrasion resistance, lubricity, and the like under a high-temperature environment. A technology that can be diverted to components and the like used even under a high-temperature environment is an object of the functions. For such formation of a thick film, instead of an electrode containing ceramics for forming hard ceramics as a main component as in the past, an electrode obtained by compression-molding powder containing a metal component as a main component and, then, subjected to heating treatment depending on a case is used. Note that, to form a thick film according to the discharge surface treatment, since a large quantity of an electrode material is supplied to the work 11 side by a pulse of electric discharge, it is necessary to give a predetermined characteristic concerning a material and hardness of an electrode to the electrode 12, for example, hardness of the electrode 12 is decreased to some extent.

In the case of the pressing step at step S6 in manufacturing of an electrode, although powder in the outer periphery of the electrode is crushed severely through contact with the die, a pressure is not sufficiently transmitted to the inside of the electrode. Therefore, fluctuation in hardness of the electrode (a difference of hardness between the outer periphery and the inside of the electrode) occurs in that the outer periphery of the electrode is hard and the inside of the electrode is soft. Thus, in the first embodiment, a method of obtaining, paying attention to this point, an electrode for discharge surface treatment without fluctuation in hardness of an electrode is explained.

As a result of performing a manufacturing test for an electrode for discharge surface treatment using various materials, the inventors have found that a particle diameter of powder of an electrode material affects hardness of an electrode most significantly by paying attention to homogenization at the time of compression molding of powder of the electrode material to realize an electrode with substantially uniform hardness.

Table 1 is a table of a relation among an electrode material, a particle diameter of powder of the electrode material, hardness of powder of the electrode material, and fluctuation in the hardness of the electrode.

TABLE 1

| | | | | Hardness |
|---|---|---|---|---|
| | | | | Fluctuation |
| | | | | A: Without |
| | | | | Fluctuation |
| | | | | B: With Slight |
| | | Particle | | Fluctuation |
| | Electrode | Diameter | Powder | C: With |
| No. | Material | (μm) | Hardness | Fluctuation |
| 1 | CBN (Ti coat) | Small (2 | Hard | A |
| | | to 3) | | |
| 2 | Stellite 2 | Large (6) | Medium | C |
| 3 | Stellite 2 | Large (6) | Medium | B |
| | (with increased | | | |
| | paraffin | | | |
| | amount) | | | |
| 4 | Stellite 2 Fine | Small (1) | Medium | A |
| | Powder | | | |
| 5 | Stellite 3 | Large (6) | Medium | C |
| 6 | Stellite 3 Fine | Small (1) | Medium | A |
| | Powder | | | |
| 7 | Co | Small (1) | Soft | A |
| 8 | Co | Medium (4) | Soft | B |
| 9 | Co | Large (8) | Soft | C |

As shown in Table 1, “Electrode Material” that indicates materials of various electrodes, “Particle Diameter (μm)” that indicates an average particle diameter of powder the electrode materials, and “Powder Hardness” that indicates hardness of powder of the electrode materials are combined in an order of the numbers to manufacture electrodes according to the flowchart in FIG. 4. Fluctuation in the hardness of the electrodes is complied in the table. Note that, in the case of Co powder, the powder is compressed at 93.3 MPa at the pressing step at step S6.

Note that, in the “Particle Diameter”, an average particle diameter not more than 3 micrometers is referred to as “small”, an average particle diameter from 4 to 5 micrometers is referred to as “medium”, and an average particle diameter not less than 6 μm is referred to as “large”. In the “Powder Hardness”, roughly, a material with Vickers hardness equal to or lower than 500 is referred to as “soft”, a material with Vickers hardness of about 500 to 1000 is referred to as “medium”, and a material with Vickers hardness equal to or higher than 1000 is referred to as “hard”.

The “Hardness Fluctuation” indicates a difference of hardness of an electrode in a plurality of positions of the electrode. Hardness of an electrode has no relation with hardness of powder that is a material forming the electrode and has a strong relation with a degree of bond of the powder. For example, even if an electrode is formed of powder of a hard material, the electrode is softened to be fragile if a degree of bond of the powder is weak. In the present invention, a pencil scratch test for a coating film prescribed in JIS K 5600-5-4 is used as an indicator for fluctuation in hardness of an electrode. When a difference of evaluation values in a plurality of places is within three stages (e.g., B and 4B) in the test, an electrode is evaluated as “A” indicating that there is no fluctuation in hardness. When the difference is within five stages (e.g., B and 6B), an electrode is evaluated as “B” indicating that there is small fluctuation in hardness. When the difference is more than five stages, an electrode is evaluated as “C” indicting that there is fluctuation in hardness. It goes without saying that results of other equivalent tests may be used as an indicator.

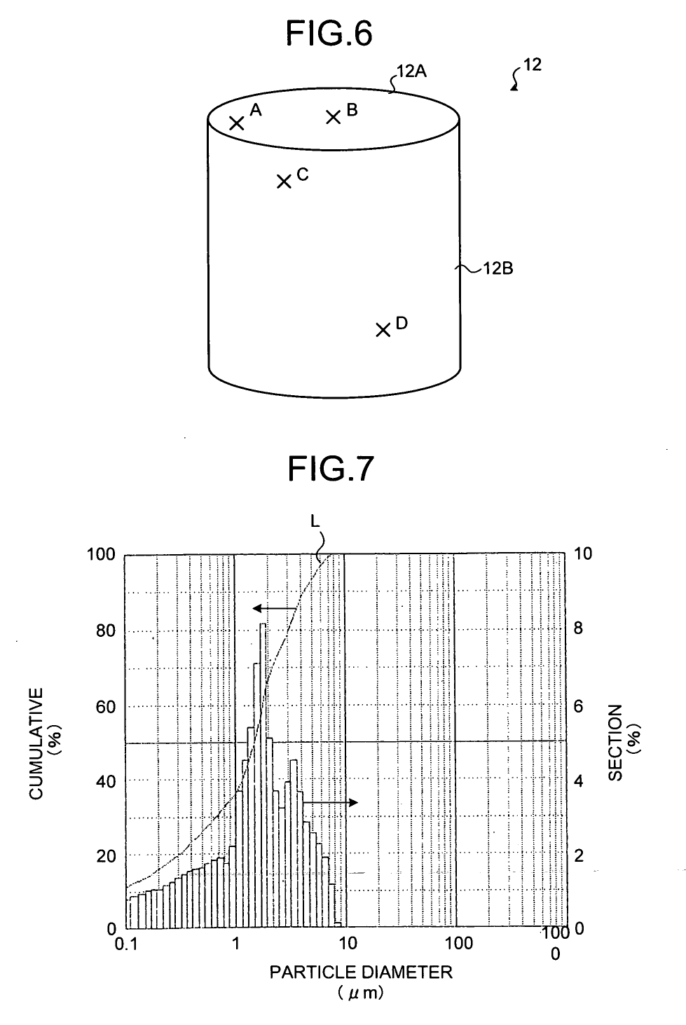

FIG. 6 is a schematic of a hardness fluctuation test. In the figure, the electrode for discharge surface treatment 12 has a cylindrical shape. A bottom surface 12A of the electrode for discharge surface treatment is a surface arranged to be opposed to a work at the time of the discharge surface treatment and is a surface on which electric discharge occurs. Fluctuation in hardness in the entire electrode 12 is evaluated. For example, fluctuation in hardness calculated from hardness of the electrode in a plurality of places (e.g., a point A and a point B) on the bottom surface 12A, fluctuation in hardness calculated from hardness of the electrode in a plurality of places (e.g., a point C and a point D) of a side 12B, fluctuation in hardness calculated from hardness of the electrode in a plurality of places (e.g., the point A and the point D) on the bottom surface (discharge generating surface) 12A and the side 12B, and fluctuation in harness calculated from hardness inside the electrode at the time when the electrode 12 is broken are evaluated.

In Table 1, an electrode material “CBN (Ti cost)” of the number 1 indicates an electrode manufactured from powder obtained by coating a surface of powder of cubic boron nitride with Ti. An electrode material “Stellite 2” of the number 2 indicates an electrode manufactured from material powder called stellite 2 that is an alloy containing Co as a main component with other components like Cr, Ni, or Mo mixed. An electrode material “Stellite 3” of the number 3 indicates an electrode manufactured from material powder called stellite 3 that is an alloy containing Co as a main component with other components like Cr, W, or Ni mixed.

From a result of an experiment shown in Table 1, as described above, it is seen that a size of a particle diameter of powder of an electrode material affects fluctuation in hardness of an electrode that occurs at the time of compression molding. Examining the result of the experiment, it is seen that there is no fluctuation in hardness of an electrode when a material with a small particle diameter is used regardless of hardness of material powder. Specifically, to manufacture a uniform molded article at the time of compression molding, it is necessary to set an average particle diameter of powder of an electrode material to about 3 micrometers or less. It is more desirable to set an average particle diameter of powder of an electrode material to about 1 micrometer or less. This makes it possible to eliminate fluctuation in hardness of an electrode. These discussions are evident from a comparison between the electrode of the number 2 and the electrode of the number 4, a comparison between the electrode of the number 5 and the electrode of the number 6, or a comparison between the electrode of the number 7 and the electrode of the number 8.

For reference, as a method of improving fluctuation in hardness of an electrode, the following two methods were also examined. A first method is a method of mixing a large quantity of wax like paraffin in material powder of an electrode considering that it is possible to make hardness of the electrode uniform by increasing fluidity in a die at the time of compression molding. However, as it is evident when the number 2 and the number 3 in Table 1 are compared, as a result of the method, uniformity of the electrode could be improved to some extent but fluctuation could not be completely eliminated. In the case of the number 3, 7 weight percent of wax is only mixed. It is possible to further improve uniformity of the electrode by further increasing a quantity of wax. However, if a quantity of wax is increased excessively, it is anticipated that bonding of powder particles of a material becomes difficult. Thus, it cannot be said that this method is a very effective method. Therefore, it is difficult to eliminate fluctuation in hardness of a molded electrode even if a large quantity of wax is mixed in material powder of the electrode.

A second method is a method of strongly compressing material powder with a relatively low press pressure by applying vibration to a mold when the material powder is put in the mold and compressed. However, even in this method, fluctuation in hardness occurred at the last stage of a press and the fluctuation could not be completely eliminated.

According to the first embodiment, it is possible to manufacture an electrode without fluctuation in hardness by setting an average value of particle diameters of powder, which is an electrode component, to 3 micrometers or less. This makes it possible to form a thick film with uniform thickness such as a film showing lubricity under a high-temperature environment.

### Second Embodiment

In a second embodiment of the present invention, an electrode for discharge surface treatment is manufactured using a plurality of kinds of powder as an electrode material.

Table 2 is a table of a relation among an electrode material, a particle diameter of powder of the electrode material, hardness of powder of the electrode material, and fluctuation in the hardness of the electrode.

TABLE 2

| | | | | Hardness |
|---|---|---|---|---|
| | | | | Fluctuation |
| | | | | A: Without |
| | | | | Fluctuation |
| | | | | B: With Slight |
| | | Particle | | Fluctuation |
| | Electrode | Diameter | Powder | C: With |
| No. | Material | (μm) | Hardness | Fluctuation |
| 1 | TiC + Ti | Small (2) + | Hard + | A |
| | | Small (3) | Soft | |
| 2 | Cr2C3 + Cr | Small (1.6) + | Hard + | A |
| | | Large (10) | Soft | |
| 3 | CBN + | Large (6) + | Hard + | C |
| | Stellite 1 | Large (6) | Medium | |
| 4 | Cr2C3 + | Small (1.6) + | Hard + | A |
| | Stellite 1 | Large (6) | Medium | |
| 5 | Al2O3 + Ni | Large (8) + | Hard + | A |
| | | Small (1) | Soft | |
| 6 | ZrO2 + Ni | Large (8) + | Hard + | A |
| | | Small (1) | Soft | |
| 7 | Stellite 2 + | Large (6) + | Medium + | A |
| | Co (2:1) | Small (1) | Soft | |
| 8 | Stellite 2 + | Large (6) + | Medium + | A |
| | Co (4:1) | Small (1) | Soft | |
| 9 | Stellite 2 + | Large (6) + | Medium + | B |
| | Co (9:1) | Small (1) | Soft | |

In the “Electrode Material” in Table 2, a material used in manufacturing an electrode is written. For example, “TiC+Ti” of the number 1 means that an electrode is manufactured by mixing TiC powder and Ti (titanium) powder at a weight ratio of 1:1. The electrode material “Stellite 2+Co (2:1)” of the number 7 means that an electrode is manufactured by mixing material powder called stellite 2 and powder of Co (cobalt) at a weight ratio of 2:1. Note that “Stellite 1” of the number 3 and the number 4 indicates an electrode that is manufactured from material powder called stellite 1 that is an alloy containing Co as a main component with other components such as Cr, W (tungsten), and Ni (nickel) mixed.

“Particle Diameter (μm)” indicates an average particle diameter of powder of respective electrode materials and indicates a particle diameter corresponding to combinations of the electrode materials. For example, “Large (6)+Small (1)” of the number 7 means that a particle diameter of stellite 2 powder in the electrode material “Stellite 2+Co” is large (a particle diameter of 6 micrometers) and a particle diameter of Co powder is small (a particle diameter of 1 micrometer). Note that, since definitions of “large”, “medium”, and “small” shown in “Particle Diameter μ” are the same as those in Table 1 in the first embodiment, explanations of the definitions are omitted.

“Powder Hardness” indicates hardness of powder of the respective electrode materials and indicates particle diameters corresponding to combinations of the electrode materials. For example, “Medium+Soft” of the number 7 means that hardness of stellite 2 powder in the electrode material “Stellite 2+Co” is medium and hardness of Co powder is soft. Since definitions of “hard”, “medium”, and “soft” shown in “Powder Hardness” are the same as those in Table 1 in the first embodiment, explanations of the definitions are also omitted. Since details of “Harness Fluctuation” are the same as those explained in Table 1 in the first embodiment, explanations of the details are omitted.

From a result of an experiment shown in Table 2, as explained in the first embodiment, it is seen that a size of a particle diameter of powder of an electrode material affects fluctuation in hardness of an electrode that occurs at the time of compression molding. When an electrode is formed by mixing powders of different materials with a large particle diameter (about 6 micrometers), hardness of the electrode is not uniform at the time of compression molding. However, it is possible to improve uniformity of hardness of the electrode by mixing powder with a small particle diameter (about 1 micrometer). Specifically, when an electrode is manufactured by mixing powders of different materials, it is possible to control fluctuation in hardness of the electrode that occurs at the time of compression molding by setting an average particle diameter of powder of one material to 3 micrometer or less and setting an average particle diameter of powder of another material to a diameter larger than 3 micrometers. Note that, as indicated by the example of the number 9 in Table 2, it was found that a mixing ratio of powder with a small particle diameter was effective in its own way for making hardness uniform even if the powder was mixed at a ratio of about 10%.

In the example described in the second embodiment, for example, as shown in the number 7 and the number 8 in Table 2, two (plural) components with different average particle diameters are mixed, for example, Co powder with a small particle diameter (not more than 3 micrometers) is mixed in stellite powder with a relatively large particle diameter (larger than 3 micrometers). However, to make components of a material in an electrode uniform, it is advisable to mix powders of an identical component and different particle diameters and mix the different components, for example, mix stellite powder with a small diameter (e.g., about 1 micrometer) in stellite powder with a relatively large particle diameter (e.g., about 6 micrometers).

There is a following meaning in mixing powder with a relatively large particle diameter and powder with a relative small particle diameter that are made of an identical material. First, manufacturing cost for an electrode is controlled. In general, manufacturing cost for powder with a small particle diameter is high. When the powder with a small particle diameter is used, electrode cost increases. Therefore, it is possible to control the electrode cost low by mixing a small quantity of powder with a small particle diameter in powder with a large particle diameter manufactured at relatively low cost. Second, a degree of melting of a material to be a film due to mixing of powders with different particle diameters is controlled. In general, a film is formed by an electrode material. However, there are a portion melted by energy of electric discharge and a portion not melted by the energy in the electrode material to be the film. As a performance required of the film, a ratio of the portion to be melted and the portion not to be melted is equal to a predetermined ratio. It is possible to control this ratio by controlling a particle diameter of powder of an electrode. Specifically, a film in a desired state is formed by using a characteristic that powder with a small particle diameter reaches a work in a state in which the powder is melted by heat of electric discharge but powder with a large particle diameter reaches a work in a state in which the powder is not completely melted.

According to the second embodiment, it is possible to manufacture an electrode without fluctuation in hardness. This makes it possible to form a thick film with uniform thickness such as a film showing lubricity in a high-temperature environment. In addition, it is possible to form an electrode without fluctuation in hardness even when a quantity of fine powder is small. This makes it possible to reduce manufacturing cost for an electrode.

In the first and the second embodiments, the technologies for manufacturing an electrode for discharge surface treatment with uniform hardness have been described. However, depending on a case, for example, when it is impossible to mix a large quantity of powder with a small particle diameter, there still remains fluctuation in hardness of an electrode. As a form often observed as fluctuation in hardness of an electrode, as described above, an outer periphery of the electrode is hardened. When fluctuation in hardness of the electrode occurs in this way, there is also a method of obtaining an electrode having uniform hardness by removing an outer periphery of the electrode after the electrode is manufactured.

### Third Embodiment

As explained in the first and the second embodiment, it is necessary that powder forming an electrode has a predetermined particle diameter in order to manufacture an electrode having uniform hardness. For example, when a film having lubricity and corrosion resistance under a high-temperature environment according to the discharge surface treatment, it is necessary to manufacture an electrode from powder with a particle diameter not more than 3 micrometers to manufacture an electrode having uniform hardness. However, only powder with limited materials is circulated in the market as the powder with a particle diameter not more than 3 micrometers. It is impossible to obtain the powder with a particle diameter not more than 3 micrometers in the market for various materials of a film formed on a surface of a work. For example, WC powder with an average particle diameter of about 1 micrometer is widely circulated in the market and can be obtained easily and at low cost. However, it is difficult to obtain other kinds of powder with a particle diameter not more than 3 micrometers. Therefore, it is impossible to manufacture electrodes for discharge surface treatment of various materials only from powder with a particle diameter not more than 3 micrometers circulated in the market. Thus, in third to seventh embodiments described below, a manufacturing method capable of manufacturing electrodes for discharge surface treatment of various materials is explained.

The third to the seventh embodiments described below mainly relate to the grinding step for powder at step S1 in the flowchart of the manufacturing process for the electrode for discharge surface treatment in FIG. 4. First, a relation between a particle diameter of powder of an electrode material and hardness of an electrode is explained. In general, an electrode is hardened when a particle diameter of powder of an electrode material is small and the electrode is softened when the particle diameter of the powder is large. For example, when an electrode is manufactured using powder with an average particle diameter of several tens micrometers as it is without performing the grinding step at step S1 in FIG. 4, the electrode has fluctuation in hardness in that hardness of the surface is high and hardness of the center is low.

When an electrode is manufactured using powder having a large particle diameter with an average particle diameter not less than several tens micrometers, the following discussion is possible as a reason for fluctuation in hardness. Spaces formed among powders relatively increases as a particle diameter increases. When a press pressure is applied to form powder with a large average particle diameter in an electrode shape, only powder on the outer side of the electrode moves to fill the spaces formed among the powders. In other words, a frictional force in the outer periphery of the electrode increases. It is possible to keep a reaction force against the press pressure only with the frictional force in the outer periphery of the electrode. Therefore, the press pressure is not transmitted to the inside of the electrode. As a result, the manufactured electrode is hard on the surface and soft in the inside.

When the discharge surface treatment is performed using such an electrode with nonuniform hardness, the surface of which is hard and the inside of which is soft, in the outer periphery of the electrode, the electrode material is not supplied to a work side because hardness of the outer periphery is high. Thus, removal machining for shaving the surface of the work like die sinking is performed. On the other hand, in the center of the electrode, the electrode material is easily supplied to the work side because hardness of the center is low. The center of the electrode is worn immediately after the treatment is started. As a result, the surface of the electrode after the discharge surface treatment has a shape with the projected outer periphery and the hollow center. When such an electrode is further used in the discharge surface treatment, since electric discharge occurs in a place where a distance between the electrode and the work is short, electric discharge occurs only in the outer periphery. This leads to removal machining for the surface of the work. In other words, it is impossible to perform deposition machining for the surface of the work. Thus, it is necessary to control fluctuation in hardness of an electrode by manufacturing an electrode using powder having a small particle diameter.

In the third embodiment, in the grinding step for powder at step S1 in FIG. 4, electrode powder of a material used for film formation is refined while being crashed and fragmented by a grinder like a ball mill apparatus. Note that it is desirable that powder has an average particle diameter not more than 3 micrometers.

Since the powder ground by the ball mill apparatus is refined while being crushed, a shape of the powder is a scaly shape having planes. A surface area of the powder is large compared with a sphere. When powder particles are compression-molded, since particles come into surface contact with one another, it is possible to manufacture an electrode having appropriate strength. Since the ground scaly powder has a characteristic that the planes are opposed to one another, it is possible to make space formed among powders extremely small. Therefore, it is possible to propagate a press pressure to the inside of the electrode at the time of press molding. Density of a film that is formed using such an electrode is also improved.

This embodiment is explained referring to a specific example in which an electrode is manufactured using powder ground by the ball mill apparatus to have an average particle diameter not more than 3 micrometers and the discharge surface treatment is performed using the electrode. An electrode manufactured from stellite powder ground to have an average particle diameter of 1.8 micrometers is given as an example. Note that the stellite powder is an alloy consisting of 25 weight percent of Cr, 10 weight percent of Ni, 7 weight percent of W, 0.5 weight percent of C (carbon), and the remaining weight percent of Co. Other than the stellite powder having this composition, stellite powder of an alloy consisting of 28 weight percent of Mo, 17 weight percent of Cr, 3 weight percent of Si (silicon), and the remaining weight percent of Co, an alloy with a ratio of 28 weight percent of Cr, 5 weight percent of Ni, 19 weight percent of W, and the remaining weight percent of Co, and the like may be used.

The electrode is manufactured from stellite powder according to the flowchart shown in FIG. 4. Thus, a detailed explanation thereof is omitted and only a part related to the third embodiment is explained. In manufacturing the electrode, stellite powder with an average particle diameter of about 50 micrometers circulated in the market was used as a material. In the stellite powder, there was stellite powder with a particle diameter as large as 0.1 millimeter or more. In the grinding step for powder at step S1 in FIG. 4, the stellite with an average particle diameter of about 50 micrometers was ground by a vibrating ball mill apparatus. As a material for a container (a pot) and balls of the vibrating ball mill apparatus, a material of ZrO₂ (zirconia) was used. A predetermined quantity of stellite to be electrode powder was put in the container (the pot) and the balls were put in the container. The container was filled with acetone serving as a solvent and stearic acid was added as a dispersant. The container (the pot) was vibrated to grind the stellite for about fifty hours.

Stearic acid is a surface active agent playing a role of controlling aggregation of refined particles. The dispersant is not limited to stearic acid and any agent like non-ionic Sperse 70 (product name) or sorbitan mono-oleate may be used as long as the agent has such a role. It is also possible to use ethanol, methanol, or the like as the solvent.

FIG. 7 is a graph of a granularity distribution of stellite powder after grinding fifty hours. In the graph, an abscissa indicates a particle diameter (μm) of powder in a logarithmic scale and an ordinate indicates a ratio of powder present in sections in which the particle diameter indicated on the abscissa is divided according to a predetermined criteria (a right axis) and a cumulative ratio of the powder (a left axis). In the figure, a bar graph indicates a ratio of powder present in the respective sections provided on the abscissa. A curve L indicates a cumulative ratio calculated by accumulating ratios of powders present in the respective sections in order from a side of a small particle diameter. As shown in the figures, an average particle diameter of the stellite powder could be decreased to 1.8 micrometers by grinding for fifty hours.

Note that a granularity distribution of particles was measured by a laser diffraction/dispersion method. This measuring method utilizes a phenomenon in which, when a laser beam is irradiated on particles, amounts of dispersed light and dispersion patterns are different depending on particle diameters of the respective particles. Laser beams are irradiated on particles moving in a liquid several ten thousand times and results of the laser beam irradiation are counted to obtain a distribution. Thus, it is possible to obtain an averaged data. When scaly particles are measured, an intermediate value of a largest surface (a surface of a scale) and a smallest surface (a side of the scale) is obtained. In general, a granularity distribution of the scaly particles is broader than that of spherical particles. Using the granularity distribution obtained from this measurement method, results of the granularity distribution are accumulated from a side of a small particle diameter. A granularity at which a cumulative value of the results is 50% is set as an average particle diameter (a median diameter).

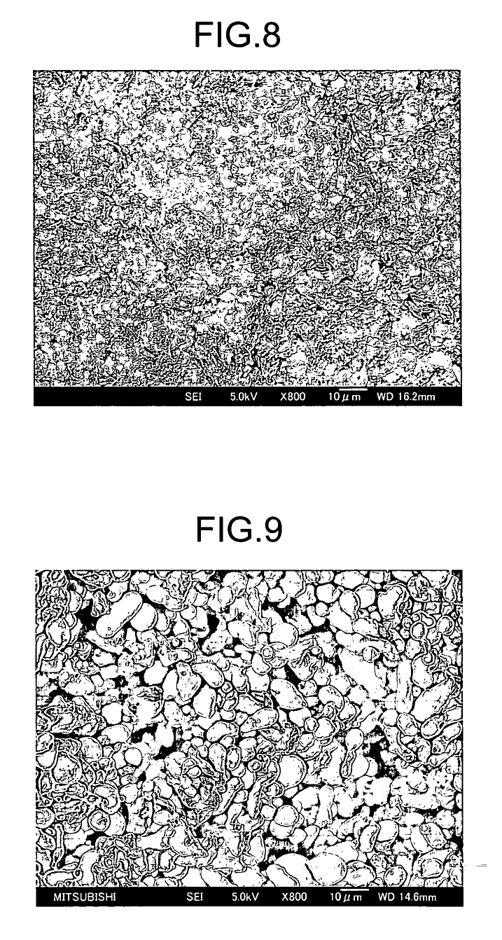

Thereafter, using the powder after grinding, an electrode was manufactured by applying a predetermined press pressure to the powder according to the flowchart in FIG. 4 such that the electrode has a shape of 18 mm×30 mm. FIG. 8 is an SEM (Scanning Electron Microscope) photograph of a state of the inside of an electrode manufactured from scaly stellite powder with an average particle diameter of 1.8 micrometers. FIG. 9 is an SEM photograph of a state of the inside of an electrode manufactured as a comparative example from spherical stellite powder with an average particle diameter of 6 micrometers.

In the electrode in the third embodiment shown in FIG. 8, since ground powder is not spherical, spaces among powder particles are small and small particles are in an extremely dense state. On the other hand, in the comparative example shown in FIG. 9, a shape of powder particles is substantially spherical and spaces among powder particles are large. The powder has a large number of spaces.

A result of performing the deposition machining (the discharge surface treatment) using this electrode is explained.

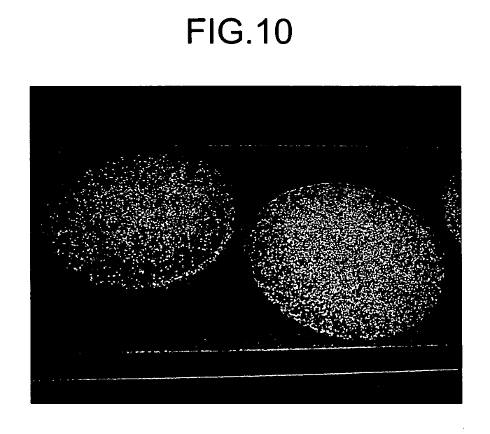

As machining conditions, a peak current value ie was set to 10 amperes and a discharge duration (a discharge pulse width) te was set to about 8 microseconds. FIG. 10 is a photograph of a deposition state at the time when a work was machined under the conditions. In the photograph, an area indicated by a circle on the left side indicates a state of a film formed by machining the work for five minutes. An area indicated by a circle on the right side indicates a state of a film formed by machining the work for three minutes. As shown in the photograph, the surface of the film is uniform and no state of occurrence of concentration of electric discharge or short-circuit is observed. Thus, it is considered that stable electric discharge occurred. Note that a film with thickness of about 1 millimeter could be formed in five minutes.

In the case of a green compact electrode of irregular-shaped particles that are not the spherical particles described above, proper bonding among particles is obtained. When electric discharge occurs, a quantity of electrode powder supplied from the electrode becomes an optimum quantity. When the electrode powder of the optimum quantity is supplied, since temperature of an arc column does not fall, it is possible to melt an upper surface of the work with an arc. Since the electrode powder is deposited on the work, the electrode powder changes to a film having a strong bonding force. Moreover, the electrode material is also sufficiently melted during movement to the work and deposited on the work in that state. Thus, discharge traces formed on the surface of the work are nearly flat. A film formed by stacking the flat discharge traces is dense.

According to the third embodiment, since the ball mill apparatus is used, it is possible to obtain powder with a desired particle diameter for manufacturing an electrode with uniform hardness at low cost. Since electrode powder is crushed and fragmented by the balls, aspherical scaly powder is obtained. As shown in FIG. 8, the scaly powder has a tendency that directions of powders are aligned. Thus, spaces formed in the electrode are reduced in size. Therefore, a press pressure is transmitted to the inside of the electrode at the time of electrode molding. It is possible to manufacture a dense electrode having uniform hardness. Moreover, since the electrode is dense, there is an effect that it is possible to also make a film to be formed dense.

In Japanese Patent Application Laid-Open No. H5-116032, as a manufacturing method for a graphite electrode for discharge machining, a jet mill apparatus is used for grinding a mixture of a binder and a carbonaceous material to obtain a desired particle diameter. When the binder and the carbonaceous material are mixed, a large mass just like one formed when water is mixed in flour is formed. Thus, the grinding is performed to resolve the mass to obtain a desired particle diameter. In other words, the grinding is not for grinding the power but for resolving the large mass. Therefore, the grinding is different from the grinding in the third embodiment for changing a shape of powder and refining the powder itself.

Japanese Patent Application Laid-Open No. H5-116032 relates to discharge machining with an object of controlling wear of an electrode and removing a work. When a work is machined using an electrode manufactured by the method described above, since the work is removed, it is impossible to form a film as described in the third embodiment.

### Fourth Embodiment

In a fourth embodiment of the present invention, in an example explained below, powder having a desired component is ground into aspherical powder with particle diameter not more than 3 micrometers by a planetary ball mill apparatus.

At the grinding step for powder at step S1 of the flowchart shown in FIG. 4, stellite powder with an average particle diameter of 6 micrometers was ground for three hours by the planetary ball mill apparatus to be refined into powder with an average particle diameter of 3 micrometers. Note that a container made of zirconia with a capacity of 500 cc and grinding balls made of zirconia with a diameter of 2 millimeters were used. The stellite powder was the same as the stellite powder used in the third embodiment.

The planetary ball mill apparatus is an apparatus that grinds powder while rotating a container containing electrode powder, balls, and a solvent and also rotating a stand on which the container is placed. A grinding force for grinding powder of the planetary ball mill apparatus is about five to ten times as large as that of the vibrating ball mill apparatus. The planetary ball mill apparatus is unsuitable for treating a large quantity of powder and is suitable for treating a small quantity of powder.

A shape of powder ground by using the planetary ball mill apparatus is the same scaly shape as powder obtained by the vibrating ball mill apparatus in the third embodiment. A state inside an electrode manufactured by using scaly powder with an average particle diameter of 3 micrometers was the same as that shown in FIG. 8 in the third embodiment. In other words, when this powder is used, an electrode without fluctuation in hardness could be manufactured in the same manner as the third embodiment. When the discharge surface treatment for three minutes was performed under the same machining condition as the third embodiment, stable electric discharge could be obtained and a thick film with thickness of about 0.1 millimeter could be deposited.

According to the fourth embodiment, it is possible to obtain powder with a desired particle diameter for manufacturing an electrode with uniform hardness by using the planetary ball mill apparatus. Spaces formed inside the electrode manufactured from the powder are reduced in size. A press pressure is transmitted to the inside of the electrode at the time of electrode molding. Thus, it is possible to manufacture a dense electrode having uniform hardness. Moreover, since the electrode is dense, there is an effect that it is possible to also make a film to be formed dense.

### Fifth Embodiment

In a fifth embodiment of the present invention, in an example explained below, powder having a desired component is ground into aspherical powder with a particle diameter not more than 3 micrometers by a bead mill apparatus.

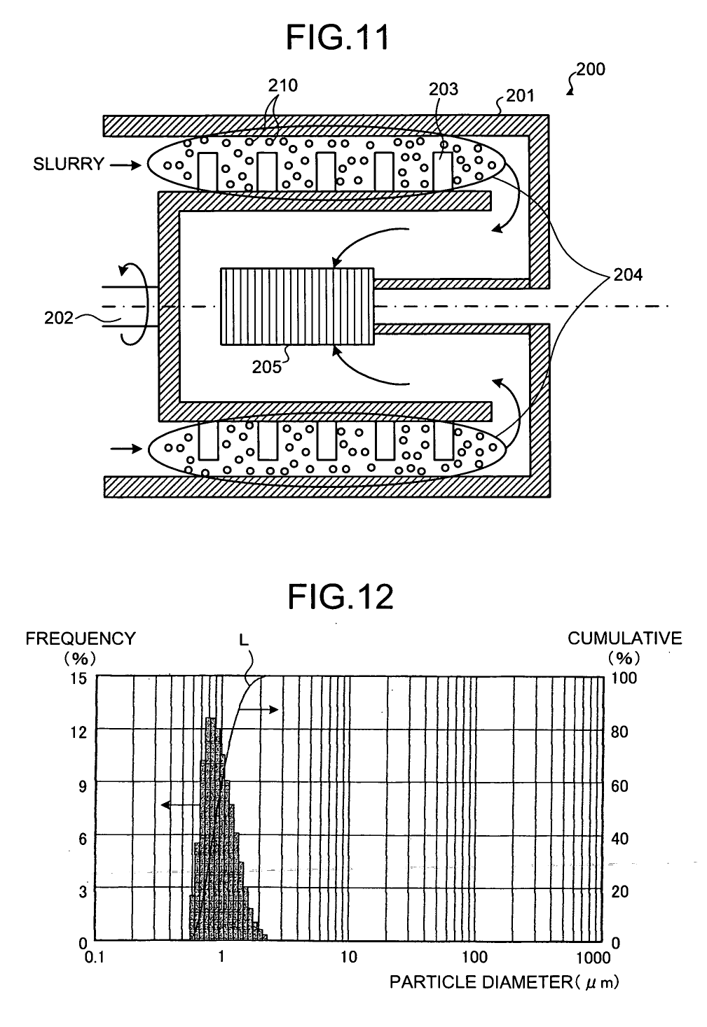

FIG. 11 is a schematic of a grinding principle of the bead mill apparatus. About 1.7 kilograms of balls (beads) 210 with a diameter of 1 millimeter made of ZrO₂ are put between a grinding container 201 and a rotor 202. Agitation pins 203 are attached to the rotor 202. When the rotor 202 is rotated, the balls 210 are agitated. Electrode powder is put into the grinding container 201. Note that the electrode powder is mixed with acetone or ethanol and put into the grinding container 201 as slurry. When the powder aggregates during grinding, it is advisable to put a dispersant into the grinding container 201 at a weight ratio of 1% to 5%. When the slurry passes an area (hereinafter, “grinding area”) 204 where the balls 210 are agitated, the electrode powder between the ball 210 and the ball 210 is crushed and refined. After passing through the grinding area 204, the slurry passes through a screen 205 serving as a filer paper and temporarily flows out to the outside of the grinding container 201. However, the slurry is circulated to return into the grinding container 201. A shape of powder ground by using the bead mill apparatus 200 is the same scaly shape as the powder obtained by the vibrating ball mill apparatus in the third embodiment and the planetary ball mill apparatus in the fourth embodiment.

The same stellite powder as that in the third embodiment was ground using such a bead mill apparatus. In this case, the rotor was rotated at peripheral speed of 10 m/s for six hours. FIG. 12 is a graph of a granularity distribution of stellite powder after grinding six hours. In the graph, an abscissa indicates a particle diameter (μm) of powder in a logarithmic scale and an ordinate indicates a ratio of powder present in sections in which the particle diameter indicated on the abscissa is divided according to a predetermined criteria (a right axis) and a cumulative ratio of the powder (a left axis). In the figure, a bar graph indicates a ratio of powder present in the respective sections provided on the abscissa. A curve L indicates a cumulative ratio calculated by accumulating ratios of powders present in the respective sections in order from a side of a small particle diameter. As shown in the figures, an average particle diameter of the stellite powder could be decreased to 1 micrometer by grinding for six hours.

Since the bead mill apparatus strikes small balls against powder at high speed to grid the powder, a grinding force of the bead mill apparatus is ten times as large as that of the vibrating ball mill apparatus. Therefore, as it is seen from comparison with FIG. 7, a granularity distribution is sharper and narrower than that in the case of the vibrating ball mill apparatus. When powder having such a sharp granularity distribution is used for electrode manufacturing, since all powders are melted under the same discharge conditions, density of a film is further improved.

According to the fifth embodiment, it is possible to obtain powder with a desired particle diameter for manufacturing an electrode with uniform hardness by using the bead mill apparatus. Spaces formed inside the electrode manufactured from the powder are reduced in size. A press pressure is transmitted to the inside of the electrode at the time of electrode molding. Thus, it is possible to manufacture a dense electrode having uniform hardness. Moreover, since the electrode is dense, there is an effect that it is possible to also make a film to be formed dense.

### Sixth Embodiment

In a sixth embodiment of the present invention, in an example explained below, powder having a desired component is ground into an aspherical powder with a particle diameter not more than 3 micrometers.

In this example, TiH₂ (titanium hydride) powder with an average particle diameter of 6.7 micrometers is refined into powder with an average particle diameter not more than 3 micrometers using a jet mill apparatus.

The jet mill apparatus is an apparatus that jets particles from nozzles opposed to each other at ultrasonic speed or speed close to the ultrasonic speed and causes the particles to collide with one another to refine powder. A shape of powder ground by the jet mill apparatus is not flattened and is a polyhedron shape having a larger number of corners unlike the shape of powder ground by the ball mill apparatus or the vibrating ball mill apparatus.

Table 3 is a table showing grinding conditions for grinding by the jet mill apparatus.

TABLE 3

| Nozzle Pressure | 5 | MPa |
|---|---|---|
| Fluid | Nitrogen | |
| Input | 2 | kg |
| Treatment Time | 15 | hr |

As shown in Table 3, TiH₂ powder was ground in nitrogen and a nozzle pressure was set to 5 MPa. The powder was repeatedly ground under the same conditions until a desired average particle diameter was obtained. An average particle diameter of the powder before grinding was 6.7 micrometers. When the grinding was continued for fifteen hours, the average particle diameter was reduced to 1.2 micrometers.

The powder ground by the jet mill apparatus was used. After applying a predetermined press pressure to the powder, the powder was heated to manufacture an electrode. The electrode was not so dense as electrodes formed of powder ground by the vibrating ball mill apparatus and the bead mill apparatus. However, the electrode was denser than an electrode molded from spherical powder. When the discharge surface treatment was performed under the same conditions as those in the third embodiment using the electrode, a dense film could be formed.

According to the sixth embodiment, it is possible to obtain powder with a desired particle diameter for manufacturing an electrode with uniform hardness by using the jet mill apparatus. It is also possible to manufacture a dense electrode having uniform hardness compared with an electrode manufactured from spherical powder.

### Seventh Embodiment

In a seventh embodiment of the present invention, in a state examined below, materials of a container and balls of a mill apparatus are mixed in a material to be ground in a process of grinding by the mill apparatus. Specifically, when Al₂O₃ (alumina) was used as materials of a container and balls of a ball mill apparatus and when ZrO₂ was used as the materials, a mixing state of the ball material was examined.

When powder is ground by the mill apparatus, the materials of the container and the balls may be mixed in the powder during grinding. Contents of Al and Zr in the powder after grinding were analyzed by an EPMA (Electron Probe Micro Analyzer). When aluminum was used as a material of the mill apparatus, 16 weight percent of Al was contained. When zirconia was used as the material of the mill apparatus, only 2 weight percent of Zr was contained. This is because abrasion resistance of zirconia at the room temperature is about ten times as high as that of aluminum. In other words, when zirconia with high abrasion resistance is used for the container and the balls of the ball mill apparatus, it is possible to control mixing of the container material and the ball material in the powder. Conversely, when it is desired to mix the ball material in the powder, it is possible to mix the ball material in the electrode material by using a material having low abrasion resistance at the room temperature as the ball material.

Thus, when it is desired not to mix the ball material at all, the container and the balls of the ball mill apparatus only have to be manufactured from a material to be ground (i.e., the same material as the powder) or the same material as the material to be ground only has to be coated on surfaces of the container and the balls of the ball mill apparatus. Examples of a method of coating include build up welding, plating, and thermal spraying.

According to the seventh embodiment, when a material is ground using the mill apparatus, it is possible to control mixing of the ball material and the like of the mill apparatus in the electrode material by appropriately selecting materials for the container and the balls of the mill apparatus. Therefore, although it has been conventionally difficult to uniformly mix powders of different materials with a particle diameter of several micrometers, since it is possible to mix the materials of the balls and the container (e.g., Al₂O₃ or ZrO₂) little by little at the time of grinding, it is possible to uniformly mix the materials in a material to be ground.

### Eighth Embodiment

As functions required of a thick film formed by discharge surface treatment in an eighth embodiment of the present invention, there are abrasion resistance, lubricity, and the like under a high-temperature environment. A technology that can be diverted to components and the like used even under a high-temperature environment is an object of the functions. As materials having such functions, oxides of Cr and Mo are known. For such formation of a thick film, instead of an electrode containing ceramics for forming hard ceramics as a main component as in the conventional discharge surface treatment, an electrode manufactured by compression-molding powder containing a metal component as a main component and, then, subjected to heating treatment depending on a case is used. To form a thick film according to the discharge surface treatment, since a large quantity of an electrode material is supplied to a work side by a pulse of electric discharge, it is necessary to give a predetermined characteristic concerning a material and hardness of an electrode to the electrode, for example, hardness of the electrode is decreased to some extent and there is no fluctuation the hardness.

Note that the fluctuation in hardness of an electrode has the following two types. (1) Fluctuation in hardness of an electrode (a difference in hardness between the outer periphery and the inside of the electrode) that means that, in a manufacturing process of the electrode, the outer periphery of the electrode is hardened and the inside thereof is softened because powder in the outer periphery is strongly crushed by contact with a die at the time of a press but a pressure is not sufficiently transmitted to the inside. (2) Fluctuation in hardness in a press direction that is caused because, when length in a direction of a press is increased, a pressure of the press is not transmitted to the inside of the electrode.

Thus, in the eighth embodiment, an electrode for discharge surface treatment that can solve fluctuation in hardness of an electrode, which occurs in an electrode manufacturing process, and manufacture a dense film at low cost is explained.

According to experiments of the inventors, facts described below have come to light concerning molding of an electrode at the time when a particle diameter of material powder of an electrode for discharge surface treatment is increased and when the particle diameter is decreased. When the particle diameter is larger than about 3 micrometers, in particular, when the particle diameter is larger than about 6 micrometers, in molding powder by press, since powder in the outer periphery is crushed strongly by contact with a die but a pressure is not sufficiently transmitted to the inside of the powder, the outer periphery of the electrode is hardened and the inside of the electrode is softened. On the other hand, when the particle diameter is smaller than about 3 micrometers, the phenomenon in which the outer periphery of the electrode is hardened as in (1) above less easily occurs when the powder is molded by press.

Facts described below have also come to light concerning formation of a film at the time when a powder particle diameter of a material of an electrode for discharge surface treatment is increased and when the powder particle diameter is decreased. In performing film formation using an electrode molded from powder with a small diameter, it is possible to form a dense film with a discharge pulse with small energy (conversely, in performing film formation using an electrode molded from powder with a small diameter, when a discharge pulse with large energy is used, spaces increase in a film or cracks are formed in the film). In performing film formation using an electrode molded from powder with a large particle diameter, it is impossible to form a film unless a discharge pulse with large energy is used. When a discharge pulse with small energy is used, it is possible to form only a coarse film with insufficiently melted powder. In other words, although it is possible to form a film using a discharge pulse with large energy, since a particle diameter is large and energy of a discharge pulse is large, spaces in the film increase and cracks are formed in the film.

In summary, for forming a dense film, it is desirable to use an electrode molded from powder with a small particle diameter and form a film using a discharge pulse with relatively small energy.

In general, spherical powder is manufactured by a method such as the atomize method. In the atomize method, powder with a particle diameter of about several ten micrometers is often manufactured. When powder with a particle diameter not more than 10 micrometers is necessary, the powder is often obtained by classifying the powder manufactured by the atomize method. When powder with a particle diameter smaller than 10 micrometers, for example, about 2 micrometers or 3 micrometers is manufactured, it is realistic to obtain the powder by grinding powder with a particle diameter of about several ten micrometers in view of cost except that a material that is in great demand such as Co is used.

The powder with a small diameter manufactured by grinding the powder is flat lather than spherical. Thus, a phenomenon in which a green compact as a compact expands further increases when a pressure of a press is released. This is because the powder flows more smoothly and is easily compressed when the power is spherical at the time of compression molding. Since it is difficult to manage an amount of expansion of the green compact obtained by molding the powder. Thus, an electrode of a different characteristic is molded every time powder is molded. This causes a significant program in terms of quality management. Therefore, to manage an electrode quality and a quality of a film to be formed, it is necessary to make an amount of expansion of the electrode equal, eliminate expansion of the electrode, or reduce an expansion amount of the electrode to be in a manageable range.

Summarizing the problems described above, it is desirable to use an electrode molded from powder with a small particle diameter and perform film formation using a discharge pulse with relatively small energy. When a powder particle diameter is small, in particular, when powder with a small diameter is manufactured by grinding, it is difficult to manufacture an electrode of a predetermined shape with press. It is necessary to cope with the difficulty.

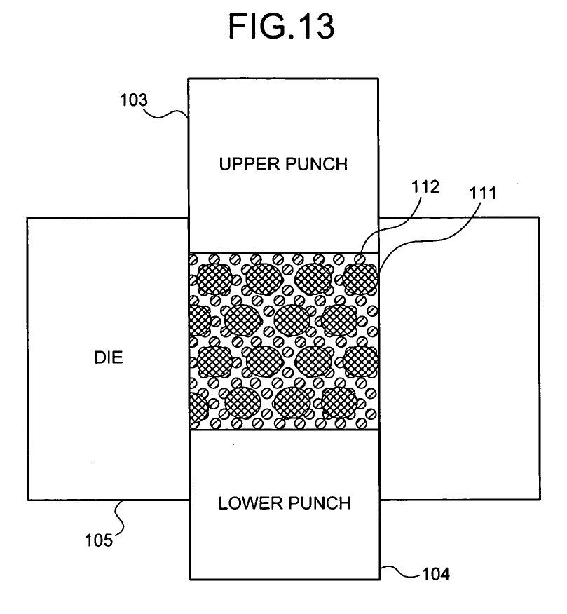

Thus, a method with which it is possible to manufacture an electrode of a predetermined shape with a press even when a particle diameter of powder is small is explained. FIG. 13 is a diagram of a schematic structure of an electrode material in the eighth embodiment. FIG. 13 is a diagram of a schematic constitution of an electrode material in the eighth embodiment. As in FIG. 5, a state in which powder is put in a molding device and compressed is schematically shown. Note that components identical with those in FIG. 5 are denoted by the identical reference signs and explanations of the components are omitted. In the eighth embodiment, as shown in FIG. 13, as powder of an electrode material, a mixture of small-diameter powder 112 having a small particle diameter distribution and large-diameter powder 111 with an average particle diameter twice or more as large as the small-diameter powder 112 or a mixture of the small-diameter powder 112 with an average particle diameter not more than 3 micrometers and the large-diameter powder 111 with an average particle diameter not less than 5 micrometers is used. Note that, in an example described in the following explanation, a mixture of the large-diameter powder 111 with a particle diameter of about 6 micrometers and the small-diameter powder 112 with a particle diameter of about 1 micrometer is used. Concerning positioning of the large-diameter powder 111 and the small-diameter powder 112, the small-diameter powder 112 is a main component of an electrode contributing to film formation and the large-diameter powder 111 is powder that is supplementarily added to improve compression properties of powder and perform stable electrode molding. A film is also formed from the large-diameter powder 111.

Both the large-diameter powder 111 and the small-diameter powder 112 to be electrode materials are Co-based alloys containing Cr, Ni, W, or the like. Besides, for thick film formation, it is possible to use, for example, a Co alloy, an Ni alloy, an Fe alloy, and the like. Note that the large-diameter powder 111 and the small-diameter powder 112 may be the same material or may be different materials. It is desirable that the large-diameter powder 111 and the small-diameter powder 112 are the same alloy material to form a film containing a predetermined alloy material as a base.

The large-diameter powder 111 and the small-diameter powder 112 are further explained. The large-diameter powder 111 is powder obtained by classifying powder manufactured by the atomize method and selecting powder with a particle diameter of about 6 micrometers. As the small-diameter powder 112, powder obtained by grinding powder having a component identical with that of the large-diameter powder 111, which is manufactured by the atomize method, to set an average particle diameter thereof to about 1 to 2 micrometers was used.

A manufacturing method for an electrode using these powders is the same as the method explained in the flowchart in FIG. 4 in the first embodiment. Thus, an explanation of the manufacturing method is omitted. As described above, only with the small-diameter powder 112, after a press, a green compact as a compact expanded when a pressure was released. However, when the spherical large-diameter powder 111 was mixed in the small-diameter powder 112, flow of powder was improved, a pressure of a press was uniformly transmitted to the electrode (the compact), and expansion of the electrode after releasing a pressure was almost eliminated.

Judging from the result of the experiment, it is desirable to set a ratio of the large-diameter powder 111 to about 5% to 60% in a volume percent. More desirably, from the viewpoint of density of a film, the ratio is in a range of about 5% to 20%. When a ratio of the large-diameter powder 111 is too small, expansion of the electrode is not eliminated. However, when the large-diameter powder 111 with a volume percent of about 5% was mixed, large expansion of the electrode was eliminated. However, when the large-diameter powder 111 is increased, under the condition that energy of a discharge pulse is small, it is difficult to form a film. When a discharge pulse with large energy is used, surface roughness of a film is increased. Therefore, it is desirable to set a ratio of the large-diameter powder 111 as small as possible.

When the large-diameter powder 111 had a small volume not more than 20%, a discharge pulse width was short and a dense film could be formed under a condition that a peak current value is low. As discharge pulse conditions at this point, the discharge pulse width te is 10 microseconds and the peak current value ie is about 10 amperes. If the discharge pulse width te is not more than 70 microseconds and the peak current value ie is not less than 30 amperes, it is possible to form a dense film.

When a material easily forming carbide is contained as a powder material, if an electrode material is supplied to a work side in a state in which the electrode material is completely melted by electric discharge, the material changes to carbide to make formation of a thick film difficult. Thus, for example, when Mo powder with a particle diameter of 0.7 micrometer was contained as a powder material, since Mo was a material easily forming carbide, it was effective for forming a dense film to use a condition that a discharge pulse width te was a relatively long discharge pulse width not less than 60 microseconds and supply the material not completely melted to a work.

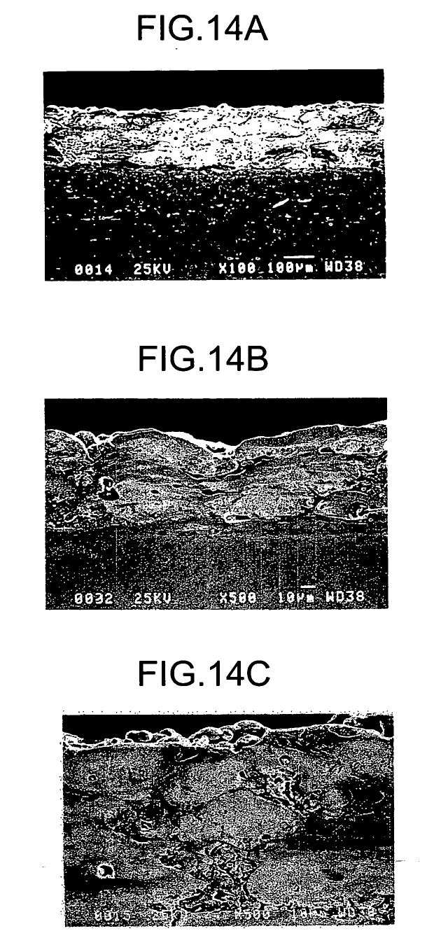

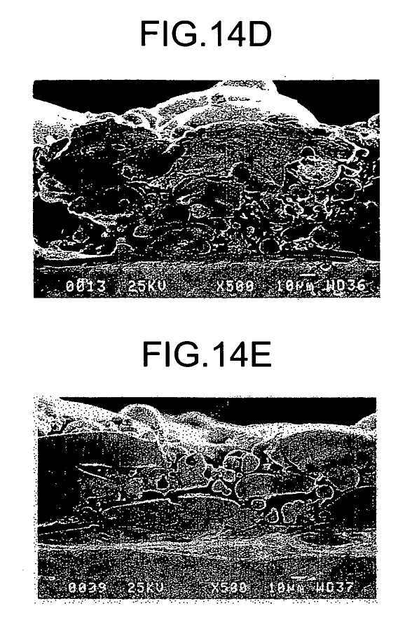

FIGS. 14A to 14E are SEM photographs of states of a section of a film according to a ratio of large-diameter powder in an electrode and a difference of a magnitude of energy of a discharge pulse. FIG. 14A is a state in which an electrode with a ratio of large-diameter powder of 10% was used to perform the discharge surface treatment under a discharge pulse condition that the peak current value ie is 10 amperes and the pulse width te is 8 microsecond. FIG. 14B is a state in which an electrode with a ratio of large-diameter power of 50% was used to perform the discharge surface treatment under a discharge pulse condition that the peak current value ie is 10 amperes and the pulse width te is 8 microseconds. FIG. 14C is a state in which an electrode with a ratio of large-diameter powder of 50% was used to perform the discharge surface treatment under a discharge pulse condition that the peak current value ie is 10 amperes and the pulse width te is 64 microseconds. FIG. 14D is a state in which an electrode with a ratio of large-diameter powder of 80% was used to perform the discharge surface treatment under a discharge pulse condition that the peak current value ie is 10 amperes and the pulse width te is 8 microseconds. FIG. 14E is a state in which an electrode with a ratio of large-diameter powder of 80% was used to perform the discharge surface treatment under a discharge pulse condition that the peak current value ie is 10 amperes and the pulse width te is 64 microseconds. Note that a magnification in FIG. 14 is 100 times and a magnification in FIGS. 14B to 14E is 500 times.

In these figures, thicknesses of the film are different from one another because treatment time is different. The difference of thicknesses is unrelated to a state of the film itself. It is possible to increase thickness of a thin film if treatment time is extended. When it is necessary to manage film thickness, the film thickness may be managed according to treatment time or may be managed according to the number of discharge pulses. Volume of films that can be formed by discharge pulses are substantially the same if the discharge pulses have the same current waveform, that is, the same pulse width te and the same peak current value ie. Thus, it is effective to control film thickness according to the number of discharge pulses. When control of a film is performed according to the number of discharge pulses, management is extremely easy. This makes it possible to, for example, transmit information to a discharge surface treatment apparatus through a network and remotely manage film thickness.

When FIGS. 14A to 14E are considered, it is seen that, when a ratio of large-diameter powder is small, it is possible to form a dense film under a condition that energy of a discharge pulse is small (FIGS. 14A and 14B) but, as the ratio of large-diameter powder increase, spaces increase in the film (FIG. 14D). It is also seen that, even when the ratio of large-diameter powder is large, an electrode material transferred to a work is melted if energy of a discharge pulse is increased but, since a large quantity of the electrode material is melted by one discharge pulse, the film has a large space (FIG. 14E). In this regard, a similar phenomenon is observed even when the ratio of large-diameter powder is small (FIG. 14C). From the above description, it is seen that it is desirable to perform film formation under a condition that energy of a discharge pulse is small using an electrode with the ratio of large-diameter powder reduced. Therefore, an upper limit value of large-diameter powder is between 50 to 80 volume percent.

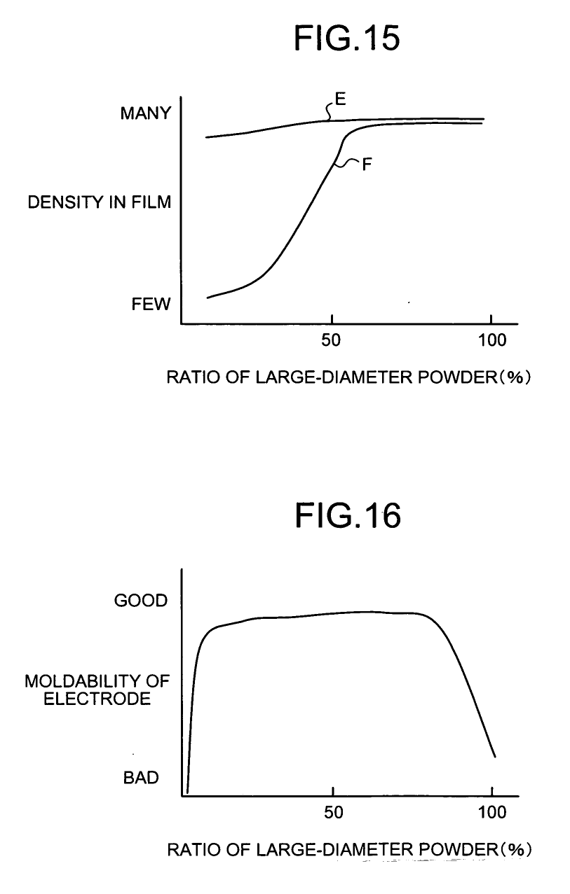

FIG. 15 is a graph of a relation between a ratio of large-diameter powder and density of a film. In the figure, an abscissa indicates a volume percentage of the large-diameter powder in an electrode volume and an ordinate indicates a ratio of spaces in a film that is formed when the discharge surface treatment is performed by an electrode indicated on the abscissa. A curve E indicates evaluation at the time when a pulse condition is large and a curve F is evaluation when a pulse condition is small. “Small” of the pulse condition indicates that the discharge surface treatment is performed under a discharge pulse condition that the peak current value ie is 10 amperes and the pulse width te is 8 microseconds. “Large” of the pulse condition indicates that the discharge surface treatment is performed under a discharge pulse condition that the peak current value ie is 10 amperes and the pulse width te is 64 microseconds.

From FIG. 15, concerning density of a film, when a volume percent of the large-diameter powder is larger than about 60%, density is deteriorated and the film has many spaces. In particular, when treatment is performed under a pulse condition with large energy, spaces increase in the film even if a ratio of large-diameter powder is reduced. However, when treatment is performed under a pulse condition with small energy, spaces in the film decrease and it is possible to form a dense film if the ratio of large-diameter powder is smaller than about 60%. In particular, when the ratio of large-diameter powder is not more than 20%, spaces in the film are extremely small in number.

FIG. 16 is a graph of a relation between a ratio of large-diameter powder and moldability of an electrode. In the figure, an abscissa indicates a volume percent of the large-diameter powder in an electrode volume and an ordinate indicates whether moldability of the electrode is good or bad. A higher point on the ordinate indicates that moldability is better. From FIG. 16, when a volume of the large-diameter powder is larger than about 80%, it is difficult to mold an electrode with a press to be uniform in hardness. An outer side of the electrode tends to be hard and an inner side of the electrode tends to be soft. Conversely, when a volume of the large-diameter powder is too small (not more than about 5%), expansion of the electrode increases when a pressure is released at the time of press and it is difficult to stabilize a quality of the electrode.

From FIGS. 15 and 16, it is desirable to set the ratio of large-diameter powder to 5% to 60% and, more desirably, about 5% to 20%. However, this ratio also depends on a shape of small-diameter powder that is a main component. In other words, if the small-diameter powder has a shape close to a spherical shape, a necessary ratio of large-diameter powder may be small. Such a result was also obtained for an electrode manufactured from powder obtained by mixing the small-diameter powder 112 having a small particle diameter distribution and the large-diameter powder 111 with an average particle diameter twice or more as large as that of the small-diameter powder 112 or an electrode manufactured from powder obtained by mixing the small-diameter powder 112 with an average particle diameter not more than 3 micrometers and the large-diameter powder 111 with an average particle diameter not less than 5 micrometers.

Note that, as the conventional inventions for forming a compact obtained by mixing and compressing powders with different particle diameters, there are Japanese Patent Application Laid-Open No. H5-148615 and Japanese Patent Application Laid-Open No. H8-300227. However, it is an object of these inventions to form a ceramic film. Ceramics serving as a main component of a film is small-diameter powder. Metal powder used as a binder is large-diameter powder. This is because, in general, it is difficult to obtain small-diameter powder as the metal powder. This is different from the contents of the present invention. This means that the inventions described in Japanese Patent Application Laid-Open No. H5-148615 and Japanese Patent Application Laid-Open No. 8-300227 lack an idea of managing a particle diameter and giving a necessary character to an electrode.

In Japanese Patent Application Publication No. H7-4696, there is also a description that powders with different particle diameters are mixed to mold a shape. However, thereafter, a surface of an electrode is plated and used for discharge machining (machining for carving a work into a predetermined shape). This is different from the present invention.

From the above description, according to the eighth embodiment, an electrode for discharge surface treatment is manufactured by mixing large-diameter powder with a volume percent of 5% to 60% in small-diameter powder. Thus, a compact does not expand after powder is pressed and a pressure is released. It is possible to obtain an electrode with uniform hardness. As a result, there is an effect that management of an electrode is performed easily. There is also an effect that, when the discharge surface treatment is performed by such an electrode, it is possible to form a dense film on a surface of a work without fluctuation.

Note that, in the eighth embodiment, the method of separately preparing powders with different particle diameters and mixing the powders is explained. However, depending on a method of grinding powder with a large particle diameter (e.g., powder with a particle diameter of 6 micrometers), powders with different particle diameters may be mixed. For example, in grinding powder with the ball mill apparatus using zirconia balls, when powder with a particle diameter of 6 micrometers was ground by balls with a diameter of 15 millimeters, powder mainly having a distribution of powder with a particle diameter of 2 micrometers and powder having mainly having a distribution of powder with a particle diameter of 6 micrometers were mixed. This is because the ball mill cannot grind powder uniformly. As a result, powder with a small diameter and powder with a large diameter were mixed. The same effect as the effect described in the eighth embodiment was obtained by using the powder. However, it goes without saying that, since an error easily occurs in reproduction of a distribution of powder in grinding, the use of the powder is limited to use in a range in which an error can be allowed.

### Ninth Embodiment

As indicated in the embodiments described above, as a method of setting hardness of an electrode containing a metal component as a main component uniform, a particle diameter of powder used as an electrode component only has to be set to 3 micrometers or less or a predetermined quantity of powder with a particle diameter not more than 3 micrometers only has to be mixed in powder used as an electrode component. This is because, in changing powder to a green compact with a press, whereas, when a particle diameter is large, for example, about 6 micrometers, an outer periphery of the green compact is pressed or rubbed strongly by a die to be hardened, when a particle diameter of powder is small, such a phenomenon does not occur.

Fluctuation in hardness of an electrode and fluctuation in a formed film are controlled by setting a particle diameter of powder used as an electrode component to 3 micrometers or less or mixing a predetermined quantity of powder with a particle diameter not more than 3 micrometers in powder used as an electrode component. However, a large number of air gaps are present in the film.

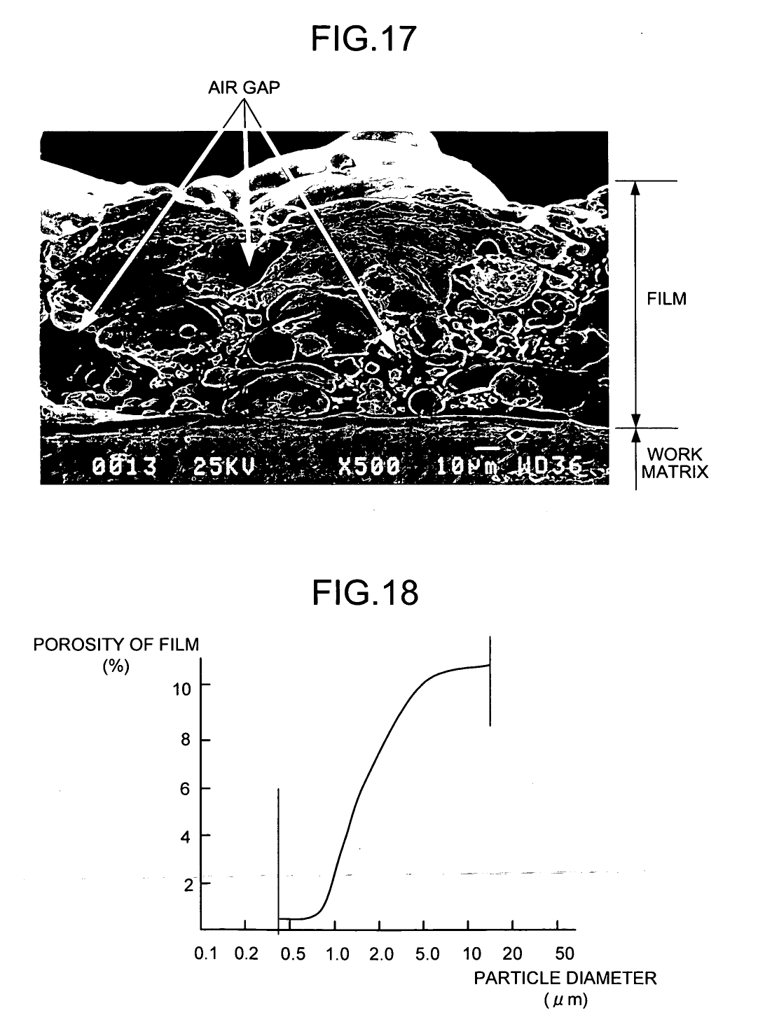

FIG. 17 is an SEM photograph of a state of a section of a film formed by the discharge surface treatment using an electrode manufactured from powder obtained by mixing Co-based metal powder with a particle diameter of 6 micrometers and Co-based metal powder with a particle diameter of 1 micrometer at a ratio of 4:1. As supplementarily indicated on the right side of this photograph, a lower side of the photograph is a work serving as a matrix and a film is formed on an upper side of the photograph. As shown in FIG. 17, although the film is formed on the work, there are many spaces and a ratio of the spaces is about 10%. Therefore, it is difficult to say that it is possible to form a sufficiently dense thick film with the electrode described above. Note that it was found, through experiments of the inventors, that, when a particle diameter was large, a film was not formed dense exceeding a certain degree no matter how machining conditions were changed.

Note that, in ninth and tenth embodiments described below. It is a main object to form a film or a thick film containing metal or an alloy as a main component. It is mainly anticipated that a material containing metal or an alloy as a main component is used as an electrode. However, to form a metal film, a material of an electrode does not always have to be metal itself. For example, it is also possible to use a metallic compound like a hydride of metal that is a compound of metal but changes to a state equivalent to metal when the material is heated to be a film.

In an explanation in the ninth embodiment, an electrode for discharge surface treatment is manufactured with an average particle diameter of power set to 1 micrometer or more. An electrode for discharge surface treatment was manufactured using Co powder with an average particle diameter not more than 1 micrometer according to the flowchart shown in FIG. 4 in the first embodiment.

As explained in the eighth embodiment, to form a dense film according to the discharge surface treatment, it is desirable to perform film formation with a discharge pulse having relatively small energy using an electrode obtained by molding powder with a small particle diameter. A discharge pulse applied between the electrode and a work is as shown in FIGS. 3A and 3B. In FIGS. 3A and 3B, roughly, a current pulse is a rectangular wave. However, it goes without saying that the same discussion applies when the current pulse has other waveforms. As shown in FIG. 3B, when the current pulse is a rectangular wave, it is possible to roughly compare energy of a discharge pulse as a product of the discharge pulse width te and the peak current value ie.

Through experiments of the inventors, it has been clarified that, depending on a powder diameter of an electrode component, there is a limit in porosity of a film to be formed, that is, a ratio of portions not filled with a material in the film. FIG. 18 is a graph of a relation between a particle diameter of powder forming an electrode and porosity of a film. In the figure, an abscissa indicates a particle diameter (μm) of powder forming an electrode and an ordinate indicates porosity in a film formed by the electrode consisting of the powder having the particle diameter on the abscissa. Conditions of electric discharge under which a densest film can be formed vary depending on constitution factors of the electrode, for example, a particle diameter and a material of powder. However, roughly, as shown in FIG. 18, the relation between a particle diameter of the electrode and porosity of the film is a relation in which porosity falls as the particle diameter is reduced.

It was found that density of a film started increasing from a particle diameter not more than 1 micrometer and it was possible to form a film in which almost no space was present. It can be considered that this is because, when a particle diameter is small, since it is possible to sufficiently melt a material with a discharge pulse having small energy and an electrode material changes to small melted metal particles to reach a work, it is possible to form a deposit with a small number of gaps.

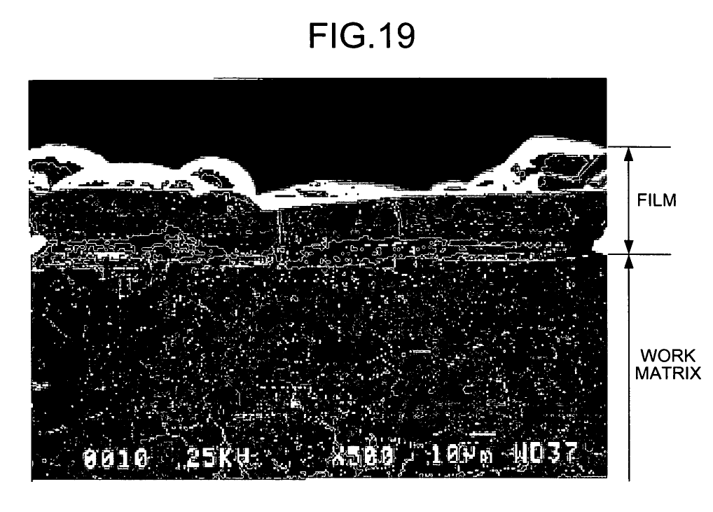

FIG. 19 is an SEM photograph of a state of a section of a film formed by the discharge surface treatment using an electrode manufactured from Co alloy powder with a particle diameter of 0.7 micrometer. This Co alloy is a Co-based alloy containing Cr, Ni, W, or the like. AS a condition of a discharge pulse in this case, a condition that energy is relatively small with the discharge pulse width te set to 8 microseconds and the peak current value ie set to 10 amperes is used. As shown in FIG. 19, there is almost no space in a film formed on a work. Note that, although the film was formed using the electrode of a Co alloy in FIG. 19, the same result could be obtained with an electrode consisting of Co powder.

When the discharge surface treatment is performed under a condition that energy of a pulse is relatively large, for example, the discharge pulse width te is about 60 microseconds, since discharge energy increases (about 7.5 times), porosity increases. Therefore, it has been confirmed that porosity differs depending on a discharge pulse condition even if an electrode is identical.

It has been confirmed through experiments that, in the case of an electrode molded manufactured from Co powder with a particle diameter not more than 1 micrometer, as a condition of a discharge pulse, preferably, the discharge pulse width te is not more than 20 microseconds and the peak current value ie is not more than 30 amperes and, more preferably, the discharge pulse width te is about 10 microseconds and the peak current value ie is about 10 amperes. A discharge pulse exceeding such a discharge pulse condition is undesirable because spaces increase and cracks increase in a film.

As described above, a dense film could be formed by setting an average particle diameter of powder as small as 1 micrometer or less. However, all powders do not have to be not more than 1 micrometer. No problem occurred in forming a dense film even if powder with a particle diameter twice or more as large as this particle diameter was contained at a maximum weight ratio of, for example, about 20%. Conversely, it was found that a problem described below could be solved by mixing a small quantity of powders with a large particle diameter. When fine powder with a particle diameter not more than 1 micrometer is compression-molded, an electrode as a compact expands greatly at a point when a pressure of a press is released. However, the expansion could be controlled by mixing a small quantity of large-diameter powder. However, when excessively large quantity of the large-diameter powder is mixed, a problem occurs in density of a film. Thus, a ratio of the large-diameter powder to be mixed is desirably about 20% in volume. In other words, about 80% of powder with a particle diameter not more than 1 micrometer is necessary.

According to the ninth embodiment, since the discharge surface treatment is performed using a green compact manufactured from powder of metal or an alloy with an average particle diameter not more than 1 micrometer, there is an effect that density of a thick film to be formed increases and it is possible to form a film in which almost no space is present. The film formed in that way is extremely strong.

### Tenth Embodiment

As described above, in the present invention, formation of a thick film by a pulse discharge is performed using an electrode manufactured from a material containing a metal component as a main component. However, it was found, through experiments of the inventors, when oil was used as a machining fluid, if a large quantity of a material easily forming carbide was contained in the electrode, the material reacted with carbon in the oil to change to carbide, making it difficult to form a thick film. Thus, when a film was formed by an electrode manufactured by using powder with a particle diameter of about several micrometers, a dense film could be formed by putting a material less easily forming carbide such as Co, Ni or Fe in the electrode.

However, it was found that, when a particle diameter of powder used for an electrode was reduced to about 1 micrometer or less, a thick film could be formed even if an electrode consisted only of powder of metal easily forming carbide, for example, Mo. Note that, a pulse condition at this point was a condition that energy of a discharge pulse was relatively small with the discharge pulse width te set to 8 microseconds and the peak current value ie set to 10 amperes. As a result of analyzing a film with X-ray diffraction, it was found that, whereas a film formed using an electrode consisting of Mo powder with a large particle diameter of about 4 micrometers tested as a comparative example contained mainly molybdenum carbide and contained almost no metal molybdenum, a film formed using an electrode consisting of Mo powder with a small particle diameter (0.7 micrometer) contained a large quantity of molybdenum in a metal state.

As described above, it was confirmed from experiments that, although a component in a metal state, which did not change to carbide, was required to be contained in a film to form a thick film, by reducing a particle diameter, even metal easily forming carbide could change to a film in a state in which the metal was not carbonized. A cause of this phenomenon has not been clarified completely. However, it is considered that an electrode material changes to a film without being carbonized because, since the particle diameter is reduced, energy of a discharge pulse for forming a dense film decreases and the energy is not enough for carbonizing the electrode material.

In the explanation of the tenth embodiment, a material of the electrode is molybdenum. The same result could be obtained with metal such as Cr, W, Zr (zirconium), Ta (tantalum), Ti, V (vanadium), and Nb (niobium). However, Ti is a material extremely easily carbonized compared with the other kinds of metal and less easily forming a thick film compared with the other kinds of metal. Since powder is easily oxidized when the powder is refined, it is necessary to gradually oxidize metal that is easily oxidized, in particular, Cr or Ti until an electrode is formed. This is because, if powder not oxidized is treated, deficiency due to sudden oxidation occurs.

According to the tenth embodiment, there is an effect that, even if metal easily oxidized is used, it is possible to reduce a percentage of an electrode material to be carbonized and form a dense thick film by setting a particle diameter to 1 micrometer or less and performing the surface discharge treatment under predetermined machining conditions. Therefore, it is possible to expand a range of materials from which a thick film can be formed and form a dense thick film from not only metal containing Co, Ni, Fe, or the like as a base but also other kinds of metal.

As explained above, according to the present invention, since an electrode was manufactured using powder with an average particle diameter not more than 3 micrometers, an electrode without fluctuation in hardness could be manufactured. It is possible to form a uniform thick film such as a film showing lubricity under a high-temperature environment. It is also possible to form an electrode without fluctuation in hardness even when a quantity of fine powder is small. Thus, it is possible to reduce electrode cost.

According to the present invention, it is possible to manufacture electrode powder suitable for the discharge surface treatment from various materials and obtain stable electric discharge with an electrode manufactured from the electrode. It is also possible to generate films of various materials by performing the discharge surface treatment using the electrode. Moreover, according to the present invention, it is possible to form a film that has a uniform composition and is uniform.

Furthermore, it is possible to form a uniform and dense thick film by performing the discharge surface treatment using an electrode for discharge surface treatment manufactured by using powder with an average particle diameter set to 1 micrometer.

### INDUSTRIAL APPLICABILITY

As described above, the present invention is suitable for a discharge surface treatment apparatus capable of automating treatment for forming a thick film on a surface of a work.

1-59. (canceled)

60. An electrode for discharge surface treatment of a work piece, the electrode being made of a green compact obtained by compression-molding an electrode material including powder of any of a metal and a metallic compound, and the discharge surface treatment generating an electric discharge between the electrode and the work piece in an atmosphere of a machining medium and forming a film of a machining material on a surface of a work piece using energy produced by the electric discharge, wherein
the powder has an average particle diameter of not less than 10 nanometers and not more than 3 micrometers, and the electrode material of the electrode has substantially uniform composition and capable of forming a thick film with thickness not less than 100 micrometers.

61. The electrode according to claim 60, wherein the powder includes any one selected from a group essentially consisting of stellite, Ti-coated CBN, Tic+Ti, Cr₂C₃+Cr, Cr₂C₃+stellite, Al₂O₃+Ni, ZrO₂+Ni, and stellite+Co.

62. The electrode according to claim 60, wherein particles of the powder have an aspherical shape.

63. The electrode according to claim 62, wherein particles of the powder are any one of scaly and polygonal in shape.

64. The electrode according to claim 60, wherein the powder has an average particle diameter of not less than 10 nanometers and not more than 1 micrometer.

65. The electrode according to claim 64, wherein the powder contains any one of Co powder, Co alloy powder, Mo powder, Cr powder, W powder, Zr powder, Ta powder, Ti powder, V powder, and Nb powder.

66. An electrode for discharge surface treatment of a work piece, the electrode being made of a green compact obtained by compression-molding an electrode material including powder of any of a metal and a metallic compound, and the discharge surface treatment generating an electric discharge between the electrode and the work piece in an atmosphere of a machining medium and forming a film of a machining material on a surface of a work piece using energy produced by the electric discharge, wherein
the powder includes a portion that has an average particle diameter of not less than 10 nanometers and not more than 3 micrometers, the portion being not less than 10% of total volume of the powder, and the electrode material of the electrode has both uniform composition and unit for hardness and is capable of forming a thick film with thickness not less than 100 micrometers.

67. The electrode according to claim 66, wherein particles of a specific component of the powder have different particle diameters.

68. The electrode according to claim 66, wherein the powder includes any one selected from a group essentially consisting of stellite, Ti-coated CBN, Tic+Ti, Cr₂C₃+Cr, Cr₂C₃+stellite, Al₂O₃+Ni, ZrO₂+Ni, and stellite+Co.

69. The electrode according to claim 66, wherein the electrode material of the electrode is capable of forming a thick film with thickness not less than 100 micrometers, and the powder contains 80% or more of powder with an average value of particle diameters not less than 10 nanometers and not more than 1 micrometer as the electrode material.

70. The electrode according to claim 69, wherein the powder contains any one of Co powder, Co alloy powder, Mo powder, Cr powder, W powder, Zr powder, Ta powder, Ti powder, V powder, and Nb powder.

71. An electrode for discharge surface treatment of a work piece, the electrode being made of a green compact obtained by compression-molding an electrode material including powder of any of a metal and a metallic compound, and the discharge surface treatment generating an electric discharge between the electrode and the work piece in an atmosphere of a machining medium and forming a film of a machining material on a surface of a work piece using energy produced by the electric discharge, wherein
the electrode material of the electrode has uniform hardness and is capable of forming a thick film with thickness not less than 100 micrometers, the powder is obtained by mixing a small-diameter powder having a distribution of small particle diameters and a large-diameter powder having an average particle diameter twice or more as large as the small-diameter powder, and the large-diameter powder is a mixture in 5 to 60 volume percent.

72. The electrode according to claim 71, wherein the small-diameter powder is metal powder refined by grinding.

73. The electrode according to claim 71, wherein the large-diameter powder has a substantially spherical shape.

74. The electrode according to claim 71, wherein the powders to be mixed have an identical component.

75. The electrode according to claim 71, wherein the powder is any one selected from a group consisting of Co alloy, Ni alloy, and Fe alloy.

76. The electrode according to claim 71, wherein the large-diameter powder is in 5 to 20 volume percent.

77. An electrode for discharge surface treatment of a work piece, the electrode being made of a green compact obtained by compression-molding an electrode material including powder of any of a metal and a metallic compound, and the discharge surface treatment generating an electric discharge between the electrode and the work piece in an atmosphere of a machining medium and forming a film of a machining material on a surface of a work piece using energy produced by the electric discharge, wherein
the electrode material of the electrode has uniform hardness and is capable of forming a thick film with thickness not less than 100 micrometers, the powder is obtained by mixing a small-diameter powder having a distribution of small particle diameters not more than 3 micrometers and a large-diameter powder having an average particle diameter not less than 5 micrometers, and the large-diameter powder is in 5 to 20 volume percent.

78. The electrode according to claim 77, wherein the small-diameter powder is metal powder refined by grinding.

79. The electrode according to claim 77, wherein the large-diameter powder has a substantially spherical shape.

80. The electrode according to claim 77, wherein the powders to be mixed have an identical component.

81. The electrode according to claim 77, wherein the powder is any one selected from a group consisting of Co alloy, Ni alloy, and Fe alloy.

82. The electrode according to claim 77, wherein the large-diameter powder is in 5 to 20 volume percent.

83. A manufacturing method for an electrode for discharge surface treatment, comprising:
a first step of grinding powder of metal, a metallic compound, or ceramics into aspheric powder having a predetermined particle diameter and scaly shape with a grinder; and
a second step of compress-molding the powder ground into a predetermined shape to have predetermined uniform hardness.

84. The manufacturing method according to claim 83, wherein the grinder is a mill apparatus.

85. The manufacturing method according to claim 84, wherein the mill apparatus is any one of a ball mill apparatus, a bead mill apparatus, a vibrating mill apparatus, and a jet mill apparatus.

86. The manufacturing method according to claim 84, wherein the mill apparatus includes a container and balls made of a same material as material of the powder to be ground.

87. The manufacturing method according to claim 84, wherein the mill apparatus includes a container and balls with surfaces thereof subjected to build up welding, plating, or thermal spraying using a same material as a material of the powder to be ground.

88. The manufacturing method according to claim 84, wherein a material of the mill apparatus is ZrO₂.

89. The manufacturing method according to claim 83, wherein, in the first step, the predetermined particle diameter is not more than 3 micrometers.

90. A method for discharge surface treatment of a work piece with an electrode, the electrode being made of a green compact obtained by compression-molding an electrode material including powder of any of a metal and a metallic compound, and the discharge surface treatment generating an electric discharge between the electrode and the work piece in an atmosphere of a machining medium and forming a film of a machining material on a surface of a work piece using energy produced by the electric discharge, comprising:
forming the film using a uniform electrode obtained by compression-molding powder with an average value of particle diameters not less than 10 nanometers and not more than 3 micrometers by using electrode material that is capable of forming a thick film with thickness not less than 100 micrometers.

91. The method according to claim 90, wherein the powder has an average value of particle diameters not less than 10 nanometers and not more than 1 micrometer.

92. The method according to claim 91, wherein
the electrode and the work piece are arranged in a machining fluid or a predetermined gas atmosphere, and
electric discharge is performed in the machining fluid or the predetermined gas atmosphere.

93. The method according to claim 91, wherein a pulse current with a discharge pulse width not more than 70 microseconds and a peak current value not more than 30 amperes is supplied between the electrode and the work piece.

94. The method according to claim 91, wherein the powder is powder of metal, a metal compound, or ceramics.

95. A method for discharge surface treatment of a work piece with an electrode, the electrode being made of a green compact obtained by compression-molding an electrode material including powder of any of a metal and a metallic compound, and the discharge surface treatment generating an electric discharge between the electrode and the work piece in an atmosphere of a machining medium and forming a film of a machining material on a surface of a work piece using energy produced by the electric discharge, comprising:
forming the film using an electrode having uniform composition and hardness and obtained by compression-molding powder mixed with powder having a particle diameter not less than 10 nanometers and not more than 3 micrometers mixed in a proportion not less than 10% in the powder, and using electrode material that is capable of forming a thick film with thickness not less than 100 micrometers.

96. The method according to claim 95, wherein the electrode contains 80% or more of powder having an average value of particle diameters not less than 10 nanometers and not more than 1 micrometer.

97. The method according to claim 96, wherein
the electrode and the work piece are arranged in a machining fluid or a predetermined gas atmosphere, and
electric discharge is performed in the machining fluid or the predetermined gas atmosphere.

98. The method according to claim 96, wherein a pulse current with a discharge pulse width not more than 70 microseconds and a peak current value not more than 30 amperes is supplied between the electrode and the work piece.

99. The method according to claim 96, wherein the powder is powder of metal, a metal compound, or ceramics.

100. A method for discharge surface treatment of a work piece with an electrode, the electrode being made of a green compact obtained by compression-molding an electrode material including powder of any of a metal and a metallic compound, and the discharge surface treatment generating an electric discharge between the electrode and the work piece and forming a film of a machining material on a surface of a work piece using energy produced by the electric discharge, comprising:
forming the film by using a uniform electrode obtained by mixing a small-diameter powder having a distribution of small particle diameters and a large-diameter powder having an average particle diameter twice or more as large as the small-diameter powder and compression-molding the powders, the large-diameter powder being in 5 to 60 volume percent, and by using electrode material that is capable of forming a thick film with thickness not less than 100 micrometers.

101. The method according to claim 100, wherein the small-diameter powder is powder refined by grinding.

102. The method according to claim 100, wherein the large-diameter powder has a substantially spherical shape.

103. The method according to claim 100, wherein the small-diameter particle and the large-diameter particle have an identical component.

104. The method according to claim 100, wherein the powder is any one of Co alloy, Ni alloy, and Fe alloy.

105. The method according to claim 100, wherein the large-diameter powder is in 5 to 20 volume percent.

106. The method according to claim 100, wherein
the electrode and the work piece are arranged in a machining fluid or a predetermined gas atmosphere, and
electric discharge is performed in the machining fluid or the predetermined gas atmosphere.

107. The method according to claim 100, wherein a pulse current with a discharge pulse width not more than 70 microseconds and a peak current value not more than 30 amperes is supplied between the electrode and the work piece.

108. A method for discharge surface treatment of a work piece with an electrode, the electrode being made of a green compact obtained by compression-molding an electrode material including powder of any of a metal and a metallic compound, and the discharge surface treatment generating an electric discharge between the electrode and the work piece and forming a film of a machining material on a surface of a work piece using energy produced by the electric discharge, comprising:
forming the film by using a uniform electrode obtained by mixing a small-diameter powder having a distribution of small particle diameters not more than 3 micrometers and a large-diameter powder having an average particle diameter not less than 5 micrometers and compression-molding the powders, the large-diameter powder being in 5 to 60 volume percent, and by using electrode material that is capable of forming a thick film with thickness not less than 100 micrometers.

109. The method according to claim 108, wherein the small-diameter powder is powder refined by grinding.

110. The method according to claim 108, wherein the large-diameter powder has a substantially spherical shape.

111. The method according to claim 108, wherein the small-diameter particle and the large-diameter particle have an identical component.

112. The method according to claim 108, wherein the powder is any one of Co alloy, Ni alloy, and Fe alloy.

113. The method according to claim 108, wherein the large-diameter powder is in 5 to 20 volume percent.

114. The method according to claim 108, wherein
the electrode and the work piece are arranged in a machining fluid or a predetermined gas atmosphere, and
electric discharge is performed in the machining fluid or the predetermined gas atmosphere.

115. The method according to claim 108, wherein a pulse current with a discharge pulse width not more than 70 microseconds and a peak current value not more than 30 amperes is supplied between the electrode and the work piece.

116. A discharge surface treatment apparatus that has an electrode consisting of a green compact obtained by compression-molding powder of metal or a metallic compound and a work piece on which a film is formed, the electrode and the work piece being arranged in a machining fluid or in an air, generates a pulsed electric discharge between the electrode and the work piece using a power supply apparatus electrically connected to the electrode and the work piece, and forms, using discharge energy of the electric discharge, a film consisting of an electrode material or a substance generated by reaction of the electrode material due to the discharge energy on a surface of the work piece, wherein
the powder has an average particle diameter of not less than 10 nanometers and not more than 3 micrometers, and the electrode material of the electrode has substantially uniform composition and capable of forming a thick film with thickness not less than 100 micrometers.

117. The discharge surface treatment apparatus according to claim 116, wherein powder with an average value of particle diameters not less than 10 nanometers and not more than 1 micrometer is used.

118. The discharge surface treatment apparatus according to claim 117, wherein
the electrode and the work piece are arranged in a machining fluid or a predetermined gas atmosphere, and
electric discharge is performed in the machining fluid or the predetermined gas atmosphere.

119. The discharge surface treatment apparatus according to claim 117, wherein a pulse current with a discharge pulse width not more than 70 microseconds and a peak current value not more than 30 amperes is supplied between the electrode and the work piece.

120. The discharge surface treatment method according to claim 117, wherein the powder is powder of metal, a metal compound, or ceramics.

121. A discharge surface treatment apparatus that has an electrode consisting of a green compact obtained by compression-molding powder of metal or a metallic compound and a work piece on which a film is formed, the electrode and the work piece being arranged in a machining fluid or in an air, generates a pulsed electric discharge between the electrode and the work piece using a power supply apparatus electrically connected to the electrode and the work piece, and forms, using discharge energy of the electric discharge, a film consisting of an electrode material or a substance generated by reaction of the electrode material due to the discharge energy on a surface of the work piece, wherein
the powder includes a portion that has an average particle diameter of not less than 10 nanometers and not more than 3 micrometers, the portion being not less than 10% of total volume of the powder, and the electrode material of the electrode has both uniform composition and unit for hardness and is capable of forming a thick film with thickness not less than 100 micrometers.

122. The discharge surface treatment apparatus according to claim 121, wherein the electrode contains 80% or more of powder having an average value of particle diameters not less than 10 nanometers and not more than 1 micrometer.

123. The discharge surface treatment apparatus according to claim 122, wherein
the electrode and the work piece are arranged in a machining fluid or a predetermined gas atmosphere, and
electric discharge is performed in the machining fluid or the predetermined gas atmosphere.

124. The discharge surface treatment apparatus according to claim 122, wherein a pulse current with a discharge pulse width not more than 70 microseconds and a peak current value not more than 30 amperes is supplied between the electrode and the work piece.

125. The discharge surface treatment method according to claim 122, wherein the powder is powder of metal, a metal compound, or ceramics.

126. A discharge surface treatment apparatus comprising:
an electrode consisting of a green compact obtained by compression-molding powder of metal or a metal compound;
a work piece on which a film is formed; and
a power supply apparatus electrically connected to the electrode and the work piece,
the discharge surface treatment apparatus generating pulse-like electric discharge between the electrode and the work piece with the power supply apparatus and forming, using discharge energy of the discharge, a film consisting of an electrode material or a substance generated by reaction of the electrode material due to the discharge energy on a surface of the work piece, wherein
a uniform electrode is manufactured from an electrode material that is obtained by mixing a small-diameter powder having a distribution of small particles and a large-diameter powder having an average particle diameter twice or more as large as the small-diameter powder, the large-diameter powder being in 5 to 60 volume percent, and the electrode material being capable of forming a thick film with thickness not less than 100 micrometers.

127. The discharge surface treatment apparatus according to claim 126, wherein the small-diameter powder is powder refined by grinding.

128. The discharge surface treatment apparatus according to claim 126, wherein the large-diameter powder has a substantially spherical shape.

129. The discharge surface treatment apparatus according to claim 126, wherein the small-diameter particle and the large-diameter particle have an identical component.

130. The discharge surface treatment apparatus according to claim 126, wherein the powder is any one of Co alloy, Ni alloy, and Fe alloy.

131. The discharge surface treatment apparatus according to claim 126, wherein the large-diameter powder is in 5 to 60 volume percent.

132. The discharge surface treatment apparatus according to claim 126, wherein the large-diameter powder is in 5 to 20 volume percent.

133. The discharge surface treatment apparatus according to claim 126, wherein
the electrode and the work piece are arranged in a machining fluid or a predetermined gas atmosphere, and
electric discharge is performed in the machining fluid or the predetermined gas atmosphere.

134. The discharge surface treatment apparatus according to claim 126, wherein a pulse current with a discharge pulse width not more than 70 microseconds and a peak current value not more than 30 amperes is supplied between the electrode and the work piece.

135. A discharge surface treatment apparatus comprising:
an electrode consisting of a green compact obtained by compression-molding powder of metal or a metal compound;
a work piece on which a film is formed; and
a power supply apparatus electrically connected to the electrode and the work piece,
the discharge surface treatment apparatus generating pulse-like electric discharge between the electrode and the work piece with the power supply apparatus and forming, using discharge energy of the discharge, a film consisting of an electrode material or a substance generated by reaction of the electrode material due to the discharge energy on a surface of the work piece, wherein
a uniform electrode is manufactured from an electrode material that is obtained by mixing a small-diameter powder having a distribution of small particles not more than 3 micrometers and a large-diameter powder having an average particle diameter not less than 5 micrometers, the large-diameter powder being in 5 to 60 volume percent, and the electrode material being capable of forming a thick film with thickness not less than 100 micrometers.

136. The discharge surface treatment apparatus according to claim 135, wherein the small-diameter powder is powder refined by grinding.

137. The discharge surface treatment apparatus according to claim 135, wherein the large-diameter powder has a substantially spherical shape.

138. The discharge surface treatment apparatus according to claim 135, wherein the small-diameter particle and the large-diameter particle have an identical component.

139. The discharge surface treatment apparatus according to claim 135, wherein the powder is any one of Co alloy, Ni alloy, and Fe alloy.

140. The discharge surface treatment apparatus according to claim 135, wherein the large-diameter powder is in 5 to 60 volume percent.

141. The discharge surface treatment apparatus according to claim 135, wherein the large-diameter powder is in 5 to 20 volume percent.

142. The discharge surface treatment apparatus according to claim 135, wherein
the electrode and the work piece are arranged in a machining fluid or a predetermined gas atmosphere, and
electric discharge is performed in the machining fluid or the predetermined gas atmosphere.

143. The discharge surface treatment apparatus according to claim 135, wherein a pulse current with a discharge pulse width not more than 70 microseconds and a peak current value not more than 30 amperes is supplied between the electrode and the work piece.
